(19) United States
(12) Patent Application Publication
(10) Pub. No.: US 2025/0377798 A1
(43) Pub. Date: Dec. 11, 2025

(54) MEMORY MODULES WITH RANDOM ACCESS MEMORY (RAM) MEMORY CHIPS SUPPORTING DISTINCT, MULTIPLE SINGLE-WORD MEMORY ACCESSES, AND RELATED MEMORY SYSTEMS AND METHODS

(71) Applicant: QUALCOMM Incorporated, San Diego, CA (US)

(72) Inventors: Shekhar Yeshwant Borkar, Beaverton, OR (US); Nitin Yeshwant Borkar, Redmond, WA (US); Rishi Khan, Wilmington, DE (US); Klaus Ruff, Beaverton, OR (US)

(21) Appl. No.: 18/737,046

(22) Filed: Jun. 7, 2024

(51) Int. Cl. G06F 3/06

(52) U.S. Cl. CPC G06F 3/0613; G06F 3/0659; G06F 3/0673

(57) ABSTRACT

Memory modules with random access memory (RAM) chips supporting distinct, multiple single-word memory accesses, and related memory systems and methods of performing memory accesses to such memory modules are disclosed. To avoid the memory module only having a full memory line resolution for a memory access, the memory module supports individually controlled access to each RAM chip. For example, a separate chip select can be provided for each RAM chip so that each RAM chip can be individually and selectively enabled. In this manner, a memory access can be performed to a specific RAM chip for memory accesses at a single data word resolution to allow higher data utilization of the memory module. This is opposed to memory accesses being limited to a full memory line resolution in the memory module. The IMM can be provided as a single IMM (SIMM) package or dual IMM (DIMM) package, as examples.

### STATEMENT FOR GOVERNMENT SUPPORT

This invention was made with Government support under Agreement No. W911NF22C0079, awarded by the Intelligence Advanced Research Projects Activity (IARPA). The Government has certain rights in the invention.

### FIELD OF THE DISCLOSURE

The field of the disclosure relates to memory that is provided in a processor-based system that includes a processor that can access the memory for retrieving computer instructions to be executed and for accessing and storing data, and more particularly to random-access memory (RAM) that can be provided in in-line memory modules (IMMs).

### BACKGROUND

Central processing units (CPUs), also known as microprocessors, perform computational tasks in a wide variety of applications. The CPU is typically provided in a processor-based system that includes other components, such as a system memory for storing data and/or software instructions. A typical CPU includes one or more processor(s) each configured to execute software instructions. The software instructions can instruct a processor to fetch data from a location in the system memory (e.g., a random-access memory (RAM)) as part of a memory read operation, perform one or more CPU operations using the fetched/read data, and generate a result. The generated result may then be stored back into the system memory as a memory write operation as part of the instruction's execution in a processor.

RAM is a common form of computer memory that can be used as a system memory in a processor-based system, for example. In a RAM, individual bits of data are stored in individual memory bit cells comprised of a transistor and a capacitor pair. A RAM is an electrical circuit that consists of a memory array of RAM bit cells. A RAM can be provided in an integrated circuit (IC) chip, which is referred to as a “RAM chip.” RAM chips can be packaged as dynamic RAM (DRAM) chips in a memory module, such as in single in-line memory modules (SIMMs) or dual in-line memory modules (DIMMs), which are common packaging and form factors used for DRAM circuits. A RAM chip may be implemented using a common die that provides four (4), eight (8), or sixteen (16) data pins (referred to herein as “x4” or “4-bit-wide,” “x8” or “8-bit-wide,” and “x 16” or “16-bit-wide,” respectively) for input and output. The amount of data that can be transferred into and out of the RAM chip is a function of the number of data pins in use and the “burst length” of the RAM chip. To provide a wider data bit width, a number of RAM chips can be included in a DRAM circuit and arranged in a parallel configuration. For example, an x8 DRAM circuit may include eight (8) ×8 DRAM chips each having its own dedicated, non-shared 8-bit data bus to support a 64-bit width to support an eight (8) byte word on the combined data bus from each of the DRAM chips. Memory bursting can be employed to then increase the effective data word that can be accessed for a given memory access. For example, a memory burst of sixteen (16) in this example would yield a 64-byte word (i.e., 64 bit width * 8 bytes).

SIMMs and DIMMs have standard configurations of DRAM circuits, such as x4 and x8 arrangements that can be used in processor-based systems. In this manner, these DIMMs are effectively “off-the-shelf” memory circuits. Use of a SIMM or DIMM can avoid the need to design a specialized DRAM circuit for a processor-based system. However, memory accesses to the DRAM in the processor-based system will be limited to the capability of the SIMM or DIMM.

### SUMMARY OF THE DISCLOSURE

Aspects disclosed herein include memory modules with random-access memory (RAM) memory chips supporting distinct, multiple single-word memory accesses. Related memory systems and methods of performing memory accesses to such memory modules are also disclosed. A memory module is a module or memory “stick” that contains a plurality of RAM chips mounted on dedicated circuit board to form a memory circuit. The circuit board of the memory module can be designed to fit in a specific sized slot on a CPU motherboard for example. As an example, the RAM chips of the memory module can be double data rate (DDR) dynamic RAM (DRAM) chips packaged in a single in-line memory module (SIMM) or dual in-line memory module (DIMM) as examples of standard form factors. The RAM chips in the memory module are cooperatively arranged to provide one or more memory channels. For example, if the memory module has a total of eight (8) DDR DRAM chips in an x4 arrangement, meaning each DRAM chip has four (4) pins to each be 4-bit data wide to support 4-bit data words, the DRAM chips can be arranged to be controlled by a common chip select into a single group of all eight (8) DRAM chips to provide a single memory channel of a 32-bit wide data bus. Memory bursting can also be employed to increase the effective data line size accessed in each memory access (e.g., memory burst of 16 in an x4 memory module yields a 64-byte memory line (i.e., a cache line of 32 bits×memory burst of 16)). With a common chip select for a memory channel, a full memory line of data striped across each of the RAM chips in a memory channel is accessed for each memory access. Some memory access workloads executed in a processor-based system have high spatial locality wherein multiple data words required to be access for performing operations are within the same memory line. Thus, accessing an entire memory line with each memory access for high spatial locality data words provides a high utilization of the memory module bandwidth. However, other memory access workloads may be irregular accesses that do not have spatial locality wherein only one or a small subset of the requested data words in an accessed memory line are utilized, leading to lower data utilization of the memory module bandwidth.

In this regard, in exemplary aspects, to avoid a restriction of the memory module only having a full memory line resolution for a memory access (e.g., a 64-byte word in a 16 burst x4 DRAM memory module), the memory module supports being able to individually control access to each RAM chip in a given memory channel to be able to obtain a subset of a full memory line. For example, a separate chip select can be provided for each RAM chip in a memory module so that each RAM chip can be individually and selectively enabled. In this manner, a memory access can be performed to a specific RAM chip of a memory channel so that the memory access can be of the size of a single data word resolution of each RAM chip (e.g., 4 bits for an x4 DRAM chip X memory bursting provided, if any) to allow higher data utilization of the memory module. This is opposed to memory accesses being limited to accessing each of the RAM chips in the memory module with a common chip select in each memory access thereby accessing a full memory line as the minimum data access resolution. In an example, a standard memory module package (e.g., a SIMM or DIMM) that supports individual access to each RAM chip can be used in a memory system and achieve the benefit of distinct, multiple single-word memory accesses to the memory module. Thus, in the memory modules disclosed herein, providing individual control of the RAM chips in its memory channel provides flexibility in the memory channel being accessed either randomly to obtain a series of data words for irregular memory workloads, or sequentially for high spatial locality memory workloads to duplicate accessing an entire memory line, as desired. However, in either scenario of random irregular memory workloads or high spatial locality memory workloads, data utilization remains high achieving a higher utilization of the memory module bandwidth. In another example, memory accesses to the individual RAM chips in a memory channel can be pipelined so that separate memory words accessed from each RAM chip (either at sequential or non-sequential addresses) can be performed in the same number of clock cycles as would be required to access an entire memory line from RAM chips in a memory channel controlled using a common chip select.

Also, with the memory modules disclosed herein providing individual RAM chip access to be able to individually control access to data words from each RAM chip distinctly, this also allows more memory pages (i.e., memory rows) in the memory channel to be open at a given time. Only one (1) memory page in a given memory bank can be open at a time. In a memory module where each of the RAM chips in a given memory channel are only controlled by a common chip select, each memory access is to a common memory line thereby forcing the opening of memory pages across each of the RAM chips in the memory channel corresponding to memory line accessed. However, in the memory modules disclosed herein with each of its RAM chips for a given memory channel distinctly accessible, each memory access is not forced to access an entire memory line striped across each of the RAM chips in the memory channel, but rather individual data words can be accessed on a per RAM chip basis. Thus, RAM chips can be individually controlled to open a memory page of a memory bank corresponding only to the accessed data word in each RAM chip independent of accesses to the other RAM chips, as opposed to having to open all the memory pages in each of the RAM chips to access an entire memory line. Thus, all the memory pages in the RAM chips that correspond to an entire memory line do not have to be opened together thereby allowing for the possibility of other memory pages not corresponding to the memory line to be able to be left open in subsequent memory accesses. In this manner, more memory pages may be able to be left open across the RAM chips in a memory channel between subsequent memory accesses, thus providing for reduced memory access latency that may be incurred from closing and opening memory pages as often.

In another example, the memory modules disclosed herein providing individual RAM chip access to be able to individually control access to data words from each RAM chip distinctly also allow for different data word organizations in the RAM chips of a memory channel. As one example, a memory line can be striped across each of the RAM chips of a memory channel in a memory module. However, multiple data words of a given memory line can still be accessed sequentially from one RAM chip of each of the RAM chips in the memory channel with the individual chip selects provided for each RAM chip. If an entire memory line is desired to be accessed, the memory module can still be controlled to access each of the data words for the memory line striped across each of the RAM chips to be asserted on a data bus sequentially to provide the entire memory line. However, if multiple data words that are not from the same memory line are desired to be accessed sequentially, the ability to individually select each RAM chip for accesses allows the different data words from different memory lines to also be accessed sequentially in the same timing as accessing an entire memory line. In another example, a memory line can be mapped into a single RAM chip in the memory module, wherein access to the entire memory line is performed by performing multiple sequential accesses to the same RAM chip. Without the ability to have individual chip selects to individually select a single RAM chip for a memory access, it may not be possible to have a memory organization in a memory module that provides for entire memory lines to be mapped into a single RAM chip.

In this regard, in one exemplary aspect, a memory module is provided. The memory module comprises a first memory channel, comprising a plurality of first RAM chips each comprising: a plurality of first data output pins; a first command/address (C/A) input; and a first chip select pin. The first memory channel also comprises at least one first C/A bus coupled to at least one first C/A input of each of the plurality of first RAM chips. The first memory channel also comprises a plurality of first chip select inputs each coupled to a respective first chip select pin of a first RAM chip of the plurality of first RAM chips. The first memory channel also comprises a plurality of first parallel data buses each coupled to the plurality of first data output pins of a respective first RAM chip of the plurality of first RAM chips. Each first RAM chip of the plurality of first RAM chips is configured to assert a first data word on a first parallel data bus of the plurality of first parallel data buses coupled to the first RAM chip, in response to a memory read address on the at least one first C/A input and a chip select enable signal on a first chip select input of the plurality of first chip select inputs coupled to the first chip select pin of the first RAM chip.

In another exemplary aspect, a memory system is provided. The memory system comprises a memory module, comprising a first memory channel. The first memory channel comprises a plurality of first RAM chips each comprising: a plurality of first data output pins of a first data width; a first command/address (C/A) input; and a first chip select pin. The first memory channel also comprises at least one first C/A bus coupled to at least one first C/A input of each of the plurality of first RAM chips. The first memory channel also comprises a plurality of first chip select inputs each coupled to a respective first chip select pin of a first RAM chip of the plurality of first RAM chips. The first memory channel also comprises a plurality of first parallel data buses each coupled to the plurality of first data output pins of a respective first RAM chip of the plurality of first RAM chips. The memory system also comprises a memory controller coupled to the memory module. The memory controller is configured to generate a memory read access by being configured to: assert a memory address on the at least one first C/A bus for an addressed RAM chip of the plurality of first RAM chips; and assert a chip select enable signal on a first chip select input of the plurality of first chip select inputs coupled to the addressed RAM chip according to the memory address. The memory module is configured to assert a first data word of the first data width on a first parallel data bus of the plurality of first parallel data buses coupled to the addressed RAM chip in response to the memory read access.

In another exemplary aspect, a method of performing a memory access to a memory module is provided. The memory modules comprising a first memory channel, comprising: a plurality of first RAM chips each comprising: a plurality of first data output pins of a first data width; a first command/address (C/A) input; and a first chip select pin. The first memory channel also comprises at least one first C/A bus coupled to at least one first C/A input of each of the plurality of first RAM chips. The first memory channel also comprises a plurality of first chip select inputs each coupled to a respective first chip select pin of a first RAM chip of the plurality of first RAM chips. The first memory channel also comprises a plurality of first parallel data buses each coupled to the plurality of first data output pins of a respective first RAM chip of the plurality of first RAM chips. The method comprises: asserting a memory address on the at least one first C/A bus for an addressed RAM chip of the plurality of first RAM chips; and asserting a chip select enable signal on a first chip select input of the plurality of first chip select inputs coupled to the addressed RAM chip according to the memory address. The method also comprises generating, by the memory module, a first data word of the first data width on a first parallel data bus of the plurality of first parallel data buses coupled to the addressed RAM chip in response to a memory read access.

### BRIEF DESCRIPTION OF THE FIGURES

FIG. 1 is a block diagram of an exemplary processor-based system that includes a memory module in the form of an in-line memory module (IMM) that includes a random access memory (RAM) circuit with a plurality of memory banks;

FIG. 2 is a block diagram of an exemplary x4 memory module in the form of an exemplary x4 IMM that can be provided as the memory module in FIG. 1, wherein the IMM includes eight (8) x4 RAM chips in an IMM providing a single memory channel, wherein each RAM chip is separately controllable to support single data word accesses from each of the RAM chips individually;

FIG. 3A is an exemplary data layout of the x4 IMM in FIG. 2, wherein the memory lines are striped across each of the RAM chips;

FIG. 3B is an exemplary data layout of the x4 IMM in FIG. 2, wherein each memory line is mapped in a single RAM chip;

FIG. 4 is an exemplary signal timing diagram illustrating the timing of signals involved in performing a memory read access to the IMM in FIG. 2 to support single data word memory accesses, but wherein the memory accesses can also be controlled to output sequential data words of a memory line;

FIG. 5 is a flowchart illustrating an exemplary process of performing a memory read access(es) in the memory module in FIG. 2;

FIG. 6 is a block diagram of an exemplary x8 memory module in the form of an exemplary x8 IMM that can be provided as the memory module in FIG. 1, wherein the IMM includes eight (8) x8 RAM chips in an IMM with four (4) RAM chips in each memory channel to provide two (2) memory channels;

FIG. 7 is an exemplary signal timing diagram illustrating the timing of signals involved in performing a memory read access to the IMM in FIG. 6 to support single data word memory accesses, but wherein the memory accesses can also be controlled to output sequential data words of a memory line;

FIG. 8 is a block diagram of an exemplary processor-based system that includes a memory system that includes one or more memory modules including, but not limited to, the memory modules in FIGS. 2 and 6, that each include multiple RAM chips in a memory module, wherein each RAM chip in each memory channel is separately controllable to support single data word accesses from each of the RAM chips individually, and that supports memory accesses according to, but not limited to, the memory read access processes in FIGS. 4, 5, and 7; and

FIG. 9 is a block diagram of an exemplary wireless communications device that includes radio-frequency (RF) components that can include a processor-based system that includes a memory system that includes one or more memory modules including, but not limited to, the memory modules in FIGS. 2 and 6, that each include multiple RAM chips in a memory module, wherein each RAM chip in each memory channel is separately controllable to support single data word accesses from each of the RAM chips individually, and that supports memory accesses according to, but not limited to, the memory read access processes in FIGS. 4, 5, and 7.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed herein include memory modules with random-access memory (RAM) memory chips supporting distinct, multiple single-word memory accesses. Related memory systems and methods of performing memory accesses to such memory modules are also disclosed. A memory module is a module or memory “stick” that contains a plurality of RAM chips mounted on dedicated circuit board to form a memory circuit. The circuit board of the memory module can be designed to fit in a specific sized slot on a CPU motherboard for example. As an example, the RAM chips of the memory module can be double data rate (DDR) dynamic RAM (DRAM) chips packaged in a single in-line memory module (SIMM) or dual in-line memory module (DIMM) as examples of standard form factors. The RAM chips in the memory module are cooperatively arranged to provide one or more memory channels. For example, if the memory module has a total of eight (8) DDR DRAM chips in an x4 arrangement, meaning each DRAM chip has four (4) pins to each be 4-bit data wide to support 4-bit data words, the DRAM chips can be arranged to be controlled by a common chip select into a single group of all eight (8) DRAM chips to provide a single memory channel of a 32-bit wide data bus. Memory bursting can also be employed to increase the effective data line size accessed in each memory access (e.g., memory burst of 16 in an x4 memory module yields a 64-byte memory line (i.e., a cache line of 32 bits×memory burst of 16)). With a common chip select for a memory channel, a full memory line of data striped across each of the RAM chips in a memory channel is accessed for each memory access. Some memory access workloads executed in a processor-based system have high spatial locality wherein multiple data words required to be access for performing operations are within the same memory line. Thus, accessing an entire memory line with each memory access for high spatial locality data words provides a high utilization of the memory module bandwidth. However, other memory access workloads may be irregular accesses that do not have spatial locality wherein only one or a small subset of the requested data words in an accessed memory line are utilized, leading to lower data utilization of the memory module bandwidth.

In this regard, in exemplary aspects, to avoid a restriction of the memory module only having a full memory line resolution for a memory access (e.g., a 64-byte word in a 16 burst x4 DRAM memory module), the memory module supports being able to individually control access to each RAM chip in a given memory channel to be able to obtain a subset of a full memory line. For example, a separate chip select can be provided for each RAM chip in a memory module so that each RAM chip can be individually and selectively enabled. In this manner, a memory access can be performed to a specific RAM chip of a memory channel so that the memory access can be of the size of a single data word resolution of each RAM chip (e.g., 4 bits for an x4 DRAM chip X memory bursting provided, if any) to allow higher data utilization of the memory module. This is opposed to memory accesses being limited to accessing each of the RAM chips in the memory module with a common chip select in each memory access thereby accessing a full memory line as the minimum data access resolution. In an example, a standard memory module package (e.g., a SIMM or DIMM) that supports individual access to each RAM chip can be used in a memory system and achieve the benefit of distinct, multiple single-word memory accesses to the memory module. Thus, in the memory modules disclosed herein, providing individual control of the RAM chips in its memory channel provides flexibility in the memory channel being accessed either randomly to obtain a series of data words for irregular memory workloads, or sequentially for high spatial locality memory workloads to duplicate accessing an entire memory line, as desired. However, in either scenario of random irregular memory workloads or high spatial locality memory workloads, data utilization remains high achieving a higher utilization of the memory module bandwidth. In another example, memory accesses to the individual RAM chips in a memory channel can be pipelined so that separate memory words accessed from each RAM chip (either at sequential or non-sequential addresses) can be performed in the same number of clock cycles as would be required to access an entire memory line from RAM chips in a memory channel controlled using a common chip select.

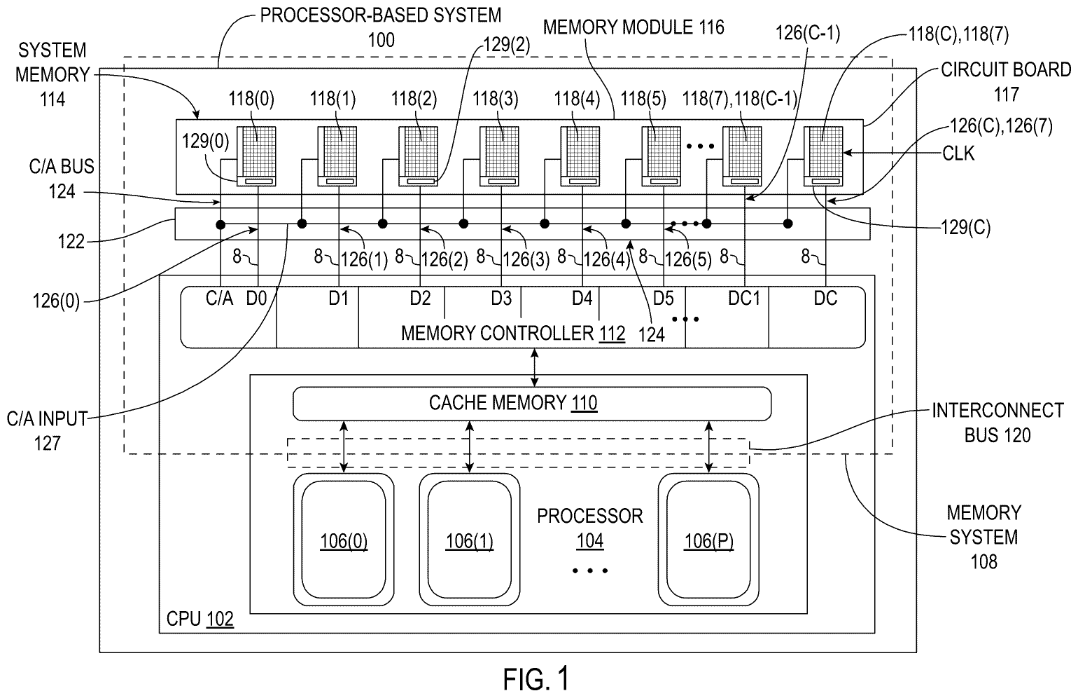

In this regard, FIG. 1 is a block diagram of an exemplary processor-based system 100 that includes a CPU 102 that includes a processor 104. The processor 104 includes a plurality of processor cores 106(0)-106(P) in this example, wherein ‘P+1’ is equal to any number of processor cores desired. The processor-based system 100 also includes a memory system 108 that includes a cache memory 110, a memory controller 112, and a system memory 114 that includes a memory module 116 clocked by a clock signal CLK in this example. A memory module is a module or memory “stick” that contains a plurality of RAM chips mounted on dedicated circuit board 117 to form a memory circuit. The circuit board 117 of the memory module 116 can be designed to fit in a specific sized slot on a CPU motherboard for example. For example, the memory module 116 may be an in-line memory module (IMM), such as a single in-line memory module (IMM) (SIMM) or a dual IMM (DIMM). Also note that the system memory 114 could include multiple memory modules. The processor 104 is conventionally partitioned from the memory module 116 on a motherboard or other circuit board. The memory module 116 includes ‘C+1’ number of parallel-arranged RAM chips 118(0)-118(C). for example, the memory module 116 in FIG. 1 may have eight (8) RAM chips 118(0)-118(7). The RAM chips 118(0)-118(C) in the memory module 116 are DRAM chips in this example. A memory read access by a processor core 106(0)-106(P) is first communicated through an interconnect bus 120 to the cache memory 110. If the memory read access results in a cache miss to the cache memory 110, the memory controller 112 is instructed to fetch the requested data through a memory interconnect 122 to the memory module 116. The memory interconnect 122 includes an electrical interface for a command/address (C/A) bus 124 and data buses 126(0)-126(C) coupled to a respective C/A input 127 and data output pins 129(0)-129(C) of each respective RAM chip 118(0)-118(C) to be routed between the processor 104 and the respective RAM chips 118(0)-118(C) in the memory module 116. The data buses 126(0)-126(C) are parallel to each other and thus also referred to herein as “parallel data buses 126(0)-126(C)”. In this example, a common shared C/A bus 124 is provided in the memory interconnect 122 and routed to each RAM chip 118(0)-118(C). Dedicated data buses 126(0)-126(C) are provided in the memory interconnect 122 and routed to each respective RAM chip 118(0)-118(C).

As shown in the processor-based system 100 in FIG. 1, the processor 104 initiates the reading of data from and the writing of data to the memory module 116 through the memory controller 112 based on execution of computer instructions (e.g., software instructions, firmware instructions). The memory controller 112 is configured to receive read data at a specified memory address (i.e., memory read address) in the RAM chips 118(0)-118(C) that was asserted on the data buses 126(0)-126(C) by the RAM chips 118(0)-118(C), in response to a memory read access asserted by the memory controller 112 on the C/A bus 124. The memory controller 112 receives and aggregates the data received on the data buses 126(0)-126(C) from an addressed respective RAM chip 118(0)-118(C) for a memory read access. The memory controller 112 is also configured to assert write data on the data buses 126(0)-226(C) to be written to a specified memory write address (i.e., a memory address) in the RAM chips 118(0)-118(C) in response to a memory write command asserted on the C/A bus 124.

In the example of the processor-based system 100 in FIG. 1, the data buses 126(0)-126(C) can be four (4) bits wide (x4) or eight (8) bits wide (x8), meaning that each RAM chip 118(0)-118(C) would be configured to support memory accesses as respective four (4) or eight (8) bit data. In the example of the memory module 116 being configured in an x4 arrangement with x4 RAM chips 118(0)-118(C), this would mean the RAM chips 118(0)-118(C) would be configured to each read and write four (4) bits from and onto their respective data buses 126(0)-126(C) at a given time in response to a clock signal. If the RAM chips 118(0)-118(C) are double data rate (DDR) memory chips, such as DDR DRAM chips, the RAM chips 118(0)-118(C) would be configured to assert/receive four (4) bits to/from their respective data buses 126(0)-126(C) on both a rising edge and falling edge of a clock signal in this example. Thus, over a period of four (4) clock cycles, if the RAM chips 118(0)-118(C) are x4 DDR RAM chips, the RAM chips 118(0)-118(C) can assert/receive four (4) bits to/from their respective data buses 126(0)-126(C) on the respective rising edges and falling edges of four (4) clock signals for a total of 32 bits or four (4) bytes (B) (4B) if there are eight (8) x4 RAM chips 118(0)-118(7). The same would also be true if the memory module 116 is configured in an x8 memory arrangement with x8 RAM chips 118(0)-118(C), but the discussion above would be for eight (8) bit widths instead of four (4) bit widths. In an x8 memory module 116, over a period of four (4) clock cycles, if the RAM chips 118(0)-118(C) are x8 DDR RAM chips, the RAM chips 118(0)-118(C) can assert/receive eight (8) bits to/from their respective data buses 126(0)-126(C) on the respective rising edges and falling edges of four (4) clock signals to provide a memory line of 64 bits or eight (8) bytes (B) (8B) if there are eight (8) x8 RAM chips 118(0)-118(7). Note that in this example, a memory line is sized according to the cache line size of the cache memory 110.

Also in this example as shown in FIG. 1, the RAM chips 118(0)-118(C) may be configured to perform a memory burst, such as a memory burst of eight (8) or sixteen (16) as non-limiting examples. Thus, in an example of an x4 memory module 116 employing a memory burst of sixteen (16), for eight (8) x4 RAM chips 118(0)-118(7) included in the memory module 116, the memory controller 112 activating the RAM chips 118(0)-118(7) in parallel for a memory read operation in a burst mode would cause a total of 64B (i.e., 4B×16 memory burst) to be asserted on the respective data buses 126(0)-126(7). In an example of an x8 memory module 116 employing a memory burst of sixteen (16), for eight (8) x8 RAM chips 118(0)-118(7) included in the memory module 116, the memory controller 112 activating the RAM chips 118(0)-118(7) in parallel for a memory read operation in a burst mode would cause a single memory line of 128B (i.e., 8B×16 memory burst) to be asserted on the respective data buses 126(0)-126(7). Alternatively, in the example of an x8 memory module 116, the eight (8) x8 RAM chips 118(0)-118(7) could be split into two (2) separate memory channels each of four (4) x8RAM chips 118(0)-118(3) and 118(4)-118(7) to support simultaneous memory accesses to each memory channel to provide two (2) 64B memory lines (i.e., each memory line would be 4B×16 memory burst).

In the memory module 116 in FIG. 1, if a common chip select is coupled to each of the RAM chips 118(0)-118(7) associated with a memory channel to activate each of those RAM chips 118(0)-118(7) for a given memory access, a full memory line of data would be accessed for each memory access. In other words, the lowest resolution of bits of each memory access would be the bit size of an entire memory line. Thus, in this scenario, a full memory line of data striped across each of the RAM chips 118(0)-118(7) in a given memory channel is accessed as for each memory access. Some memory access workloads executed by the CPU 102 in the processor-based system 100 have high spatial locality wherein multiple data words required to be accessed for performing operations are within the same memory line in the memory system 108. Thus, accessing an entire memory line with each memory access having high spatial locality data words provides a high utilization of the memory module 116 bandwidth. However, other memory access workloads executed by the CPU 102 may be irregular accesses that do not have spatial locality in the memory system 108 wherein only one or a small subset of the requested data words in an accessed memory line are utilized, leading to lower data utilization of the memory module 116 bandwidth.

In this regard, as discussed in more detail below and in exemplary aspects, to avoid a restriction of the memory module 116 only having a full memory line resolution for a memory access, the memory module 116 is configured to support distinct, individual access control to each RAM chip 118(0)-118(C) in a given memory channel to be accessed to obtain a data word from each RAM chip 118(0)-118(C) independently of each other. In other words, the memory module 116 is configured to process a memory request that provides access to a data word from each RAM chip 118(0)-118(C) independently without such memory access having to access a data word from each RAM chip 118(0)-118(C) as part of the same memory line.

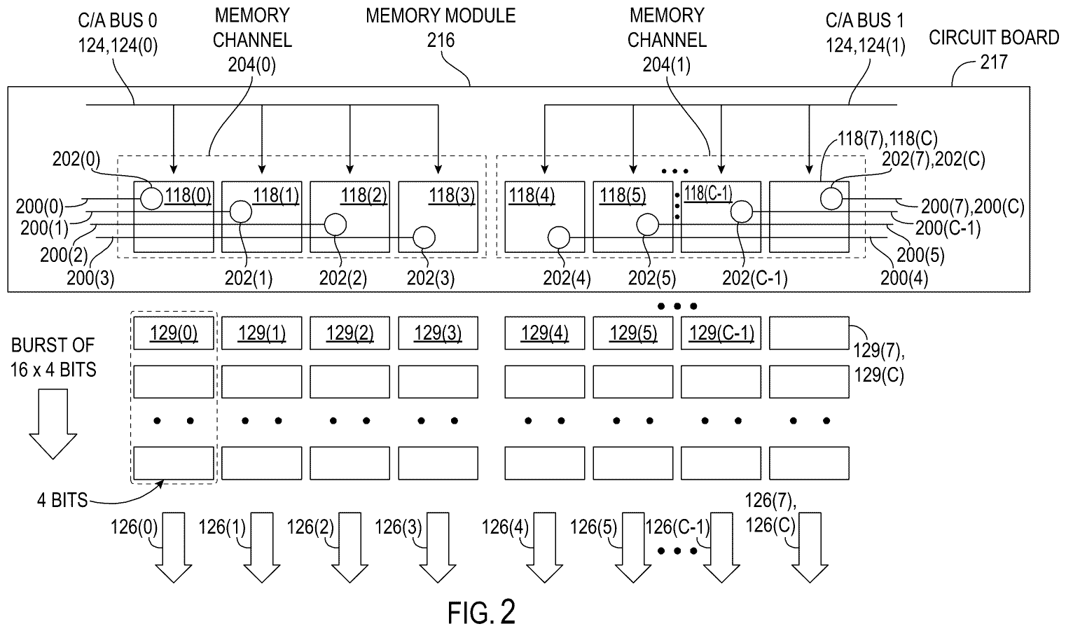

FIG. 2 illustrates a memory module 216 configured to have a separate chip select input 200(0)-200(C), 200(7) coupled to each of a respective chip select pin 202(0)-202(C) of each RAM chip 118(0)-118(C) therein so that each RAM chip 118(0)-118(C) can be individually and selectively enabled. The memory module 216 can be provided as the memory module 116 in FIG. 1. The memory module 216 is a module or memory “stick” that contains the plurality of RAM chips 118(0)-118(C) mounted on a dedicated circuit board 217 to form a memory circuit. The circuit board 217 of the memory module 216 can be designed to fit in a specific sized slot on a CPU motherboard for example. For example, the memory module 216 may be an IMM, such as a SIMM or DIMM. Common components between the memory module 216 in FIG. 2 and the memory module 116 in FIG. 1 are shown with common element numbers.

As shown in FIG. 2, the chip select pins 202(0)-202(C) of the memory module 216 are pins of the respective RAM chips 118(0)-118(C) that are configured to carry a chip select enable signal to control whether its respective RAM chip 118(0)-118(C) is activated to generate a data word on its respective data bus 126(0)-126(C) at the memory read address on the C/A bus 124 (see FIG. 1). In this manner, a memory access can be performed to specific RAM chips 118(0)-118(C) of a memory channel in the memory module 216 so that the memory access can be of the size of a single data word resolution of each RAM chip 118(0)-118(C) (e.g., 4 bits for an x4 DRAM chip X memory bursting provided, if any) to allow higher data utilization of the memory module 216. This is opposed to memory accesses to the memory module 216 being limited to accessing each of the RAM chips 118(0)-118(C) in the memory module 216 with a common chip select in each memory access thereby accessing a full memory line as the minimum data access resolution.

Thus, the memory module 216 in FIG. 2 supports individual access to each RAM chip 118(0)-118(C) that can be used in a memory system, like the memory system 108 in FIG. 1, and achieve the benefit of distinct, multiple single-word memory accesses to the memory module 216. Providing individual control of the RAM chips 118(0)-118(C) provides flexibility in a memory channel being accessed either randomly to obtain a series of data words for irregular memory workloads, or sequentially for high spatial locality memory workloads to duplicate accessing an entire memory line, as desired. However, in either scenario of random irregular memory workloads or high spatial locality memory workloads, data utilization remains high achieving a higher utilization of the memory module 216 bandwidth.

To perform a memory read access, the memory controller 112 asserts a memory read address on the C/A bus 124 to address a RAM chip(s) 118(0)-118(C). The memory controller 112 also asserts a chip select enable signal on the chip select input 200(0)-200(C) coupled to the chip select pin 202(0)-202(C) for the RAM chip 118(0)-118(7) to be accessed to activate the individual RAM chip 118(0)-118(7) selected to be accessed. In response to these signals of the memory read access, the memory module 216 and its selected activated RAM chip 118(0)-118(C) asserts a data word stored in its memory onto a respective data bus 126(0)-126(C) to be received by the memory controller 112. Because the memory module 216 is configured to be able to distinctly access each RAM chip 118(0)-118(C), in one example, the memory module 216 is configured to not assert data words from other non-selected RAM chips 118(0)-118(7) onto their respective data buses 126(0)-126(C) for the specific memory read access to the selected RAM chip 118(0)-118(7). Other data words from other RAM chips 118(0)-118(7) can be requested to be read for subsequent read access transactions in a different clock cycle(s).

To perform a memory write access, the memory controller 112 asserts a data word on a respective data bus 126(0)-126(C) of a RAM chip 118(0)-118(7) selected for the write access, a memory write address on the C/A bus 124 to address the selected RAM chip(s) 118(0)-118(C), and chip select enable signal on the chip select input 200(0)-200(C) coupled to the chip select pin 202(0)-202(C) of the selected RAM chip(s) 118(0)-118(C). In response to these signals of the memory write access, the memory module 216 and its selected activated RAM chip 118(0)-118(C) couple the data word on the respective data bus 126(0)-126(C) into a memory location in its memory according to the memory write address on the C/A bus 124. Again, because the memory module 216 is configured to be able to distinctly access each RAM chip 118(0)-118(C), in one example, the memory module 216 is configured to couple data words from other non-selected RAM chips 118(0)-118(7) onto their respective data buses 126(0)-126(C) for the specific memory write access to the selected RAM chip 118(0)-118(7). Other data words from other RAM chips 118(0)-118(7) can be requested to be written for subsequent write access transactions in a different clock cycle(s).

With continuing reference to FIG. 2, the memory module 216 in this example is an x4 memory module that has eight (8) x4 RAM chips 118(0)-118(7) each having four (4) respective data output pins 129(0)-129(C). The data buses 126(0)-126(C) are each four (4) bits in width. Each data bus 126(0)-126(C) is coupled to four (4) respective data output pins 129(0)-129(C). The RAM chips 118(0)-118(7) are each DDR DRAM chips in this example. Four (4) of the RAM chips 118(0)-118(3) are part of a first memory channel 204(0), and the other four (4) RAM chips 118(4)-118(7) are part of a second, separate memory channel 204(1). A memory channel is defined as a collection of memory chips that share a common C/A bus. Data buses 126(0)-126(3) coupled to respective RAM chips 118(0)-118(3) are part of the first memory channel 204(0). Data buses 126(4)-126(7) coupled to respective RAM chips 118(4)-118(7) are part of the second memory channel 204(1). Each memory channel 204(0), 204(1) has a dedicated C/A bus 0 124(0) and C/A bus 1 124(1) to provide respective commands and memory addresses to the RAM chips 118(0)-118(3), 118(4)-118(7) of the respective first and second memory channels 204(0), 204(1). The eight (8) separate chip select inputs 200(0)-200(7) are coupled to each respective RAM chip 118(0)-118(7), with chip select inputs 200(0)-200(3) being part of the first memory channel 204(0), and chip select inputs 200(4)-200(7) being part of the second memory channel 204(1). Memory accesses can be performed to each of the first and second memory channels 204(0), 204(1).

To perform a memory read access to each of the respective first and second memory channels 204(0), 204(1), the memory controller 112 independently asserts a memory read address on the first and second C/A buses 124(0), 124(1) to address a respective RAM chip(s) 118(0)-118(3), 118(4)-118(7). The memory controller 112 also asserts a chip select enable signal on respective chip select inputs 200(0)-200(3), 200(4)-200(7) coupled to respective chip select pins 202(0)-202(3), 202(4)-202(7) for the RAM chips 118(0)-118(3), 118(4)-118(7) to be accessed to activate the individual RAM chips 118(0)-118(3), 118(4)-118(7) selected to be accessed for each memory channel 204(0), 204(1). In response to these signals of the memory read access, the memory module 216 and its selected activated RAM chip 118(0)-118(3), 118(4)-118(7) for each memory channel 204(0), 204(1) assert a data word stored in its memory onto a respective data bus 126(0)-126(3), 124(4)-126(7) to be received by the memory controller 112 for each memory channel 204(0), 204(1). Because the memory module 216 is configured to be able to distinctly access each RAM chip 118(0)-118(7), in one example, the memory module 216 is configured to not assert data words from other non-selected RAM chips 118(0)-118(7) onto their respective data buses 126(0)-126(7) for the specific memory read access. Other data words from other RAM chips 118(0)-118(3), 118(4)-118(7) of each respective memory channel 204(0), 204(1) can be requested to be read for subsequent read access transactions in a different clock cycle(s).

To perform a memory write access in this example of the x4 memory module 216 in FIG. 2, the memory controller 112 can assert data words on respective data buses 126(0)-126(3), 126(4)-126(7) of respective RAM chips 118(0)-118(3), 118(4)-118(7) for each respective memory channel 204(0), 204(1) selected for the write access, memory write addresses on respective C/A buses 124(0), 124(1) to address the selected RAM chip(s) 118(0)-118(3), 118(4)-118(7), and a chip select enable signal on the respective chip select inputs 200(0)-200(3), 200(4)-200(7) coupled to the respective chip select pins 202(0)-202(3), 202(4)-202(7) for each memory channel 204(0), 204(1). In response to these signals of the memory write access, the memory module 216 and its selected activated RAM chips 118(0)-118(3), 118(4)-118(7) couple the data word on the respective data buses 126(0)-126(3), 126(4)-126(7) for each memory channel 204(0), 204(1) into the memory locations in their memory according to the memory write addresses on the respective C/A buses 124(0), 124(1). Again, because the memory module 216 is configured to be able to distinctly access each RAM chip 118(0)-118(3), 118(4)-118(7) for each respective memory channel 204(0), 204(1), in one example, the memory module 216 is configured to couple data words from other non-selected RAM chips 118(0)-118(3), 118(4)-118(7) onto their respective data buses 126(0)-126(3), 126(4)-126(7) of each respective memory channel 204(0), 204(1) for the specific memory write accesses to the respective memory channels 204(0), 204(1). Other data words from other RAM chips 118(0)-118(3), 118(4)-118(7) of the respective memory channels 204(0), 204(1) can be requested to be written for subsequent write access transactions in a different clock cycle(s).

As shown in FIG. 2, each data bus 126(0)-126(3), 126(4)-126(7) is 4 bits in width in this x4 memory module 216 for each memory channel 204(0), 204(1). Thus, for each memory access to a given memory channel 204(0), 204(1), the memory module 216 is configured support four (4) 4-bit data words on the respective data bus 126(0)-126(3), 126(4)-126(7) for each accessed memory channel 204(0), 204(1). Then, with memory bursting of sixteen (16) as an example, the memory module 216 can support a burst of sixteen (16) 4-bit data words sequentially on a respective data bus 126(0)-126(3), 126(4)-126(7) for each respective accessed memory channel 204(0), 204(1) for a total of 64 bits or 8B of data on each data bus 126(0)-126(7), or 64B of data across all data buses 126(0)-126(7). Thus, in the memory module 216, the RAM chips 118(0)-118(7) in the memory channels 204(0), 204(1) can be distinctly and randomly read or written to read or write eight (8) total distinct data words each of 8B for a total of a 64B from both memory channels 204(0), 204(1), or sequentially read or written in memory to provide a 64B memory line to both memory channels 204(0), 204(1), where each of the eight (8) data words are in the same memory line.

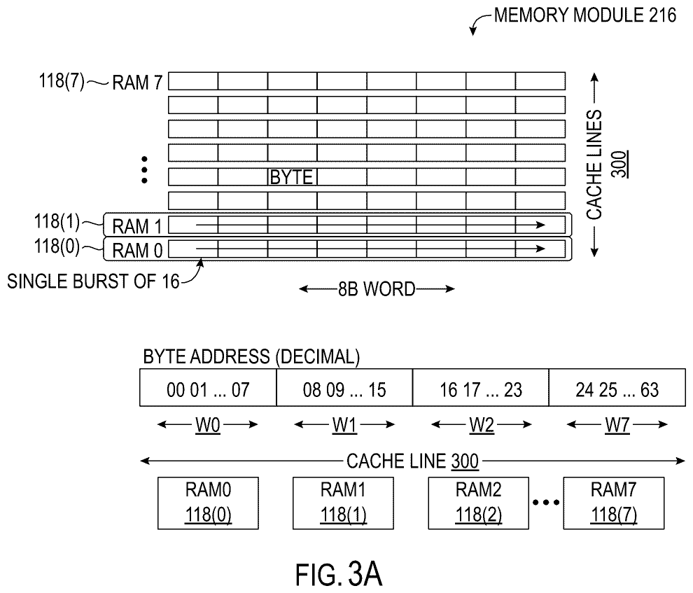

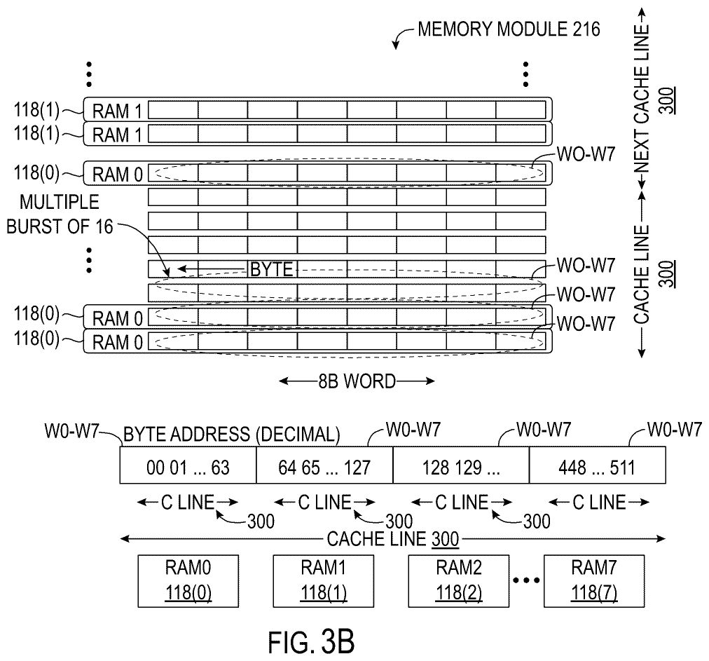

FIG. 3A is an exemplary data layout of the x4 memory module 216 in FIG. 2, wherein the memory lines as cache lines 300 are striped across each of the RAM chips 118(0)-118(7) with eight (8) RAM chips 118(0)-118(7). As shown in FIG. 3A, for each memory read access, the memory module 216 in an x4 arrangement in this data layout example is configured to provide a single 4 bit data word W0, W1, W2 . . . in a memory burst of 16 to provide an 8B data word. If an entire cache line 300 is desired to be accessed from the memory module 216, 8B data words W0-W7 can be accessed sequentially across each of the RAM chips 118(0)-118(7) corresponding to a memory read address (i.e. a memory address) of the memory read access to obtain a 64B cache line as bits 00-63 as shown in FIG. 3A. Also, in this example, up to 256 memory pages can be open at a given time in the eight (8) RAM chips 118(0)-118(7) in the memory module 216 for 8B memory accesses since there are 32 memory pages in each RAM chip 118(0)-118(7) in the memory module 216 in this example. Thus, by the memory module 216 being configured to support distinct, individual access control to each RAM chip 118(0)-118(7) in a given memory channel to be accessed distinctly to obtain a single data word from each RAM chip 118(0)-118(7) independently of each other, up to eight (8) times as many memory pages (e.g., 265 memory pages) can be open across the RAM chips 118(0)-118(7) at the same time. This is opposed to eight (8) times fewer memory pages being able to be open at the same time across the RAM chips 118(0)-118(7) if the memory module 216 is configured to only allow full memory line accesses for each memory read access. In this manner, the memory module 216 allows more memory pages to be left open across the RAM chips 118(0)-118(7) between subsequent memory accesses for reduced memory access latency.

Note that the data layout of data word striped as a memory line across each of the RAM chips 118(0)-118(7) shown in FIG. 3A for the memory module 216 is also possible for similar memory modules that are only configured to only allow full memory line accesses for each memory read access. However, the memory module 216 in FIG. 2 being configured to support distinct, individual access control to each RAM chip 118(0)-118(7), 118(C) in a given memory channel to be accessed distinctly to obtain a single data word can also allow other data layouts.

In this regard, as an example, FIG. 3B shows an exemplary data layout of the x4 memory module 216 in FIG. 2, wherein the memory lines as cache lines 300 are mapped across a single RAM chip 118(0)-118(7). For each memory read access, the memory module 216 in the x4 arrangement in this data layout example is configured to provide a single 4 bit data word in a memory burst of 16 to provide an 8B data word (W0-W7) as previously discussed. However, as shown in FIG. 3B, if it is desired to access an entire cache line 300 from the memory module 216, eight (8) 8B data words W0-W7 each can be accessed sequentially within each RAM chip 118(0)-118(7) corresponding to a memory address of the memory read access to obtain a 64B cache line. This is shown by example in FIG. 3B, where eight (8) 8B data words W0-W7 for a given cache line 300 are sequentially stored and accessed in a single RAM chip 118(0)-118(7). Also, in this example, up to 256 memory pages can be open at a given time in the eight (8) RAM chips 118(0)-118(7) in the memory module 216 for 8B memory accesses since there are 32 memory pages in each RAM chip 118(0)-118(7) in the memory module 216 in this example. Thus, again, with this data layout in FIG. 3B, by the memory module 216 being able to be configured to support distinct, individual access control to each RAM chip 118(0)-118(7) in a given memory channel to be accessed distinctly to obtain a single data word from each RAM chip 118(0)-118(7) independently of each other, up to eight (8) times as a many memory pages (e.g., 265 memory pages) can be open across the RAM chips 118(0)-118(7) at the same time. This is opposed to eight (8) times fewer memory pages being able to be open at the same time across the RAM chips 118(0)-118(7) if the memory module 216 is configured to only allow full memory line accesses for each memory read access. In this manner, the memory module 216 allows more memory pages to be left open across the RAM chips 118(0)-118(7) between subsequent memory accesses for reduced memory access latency.

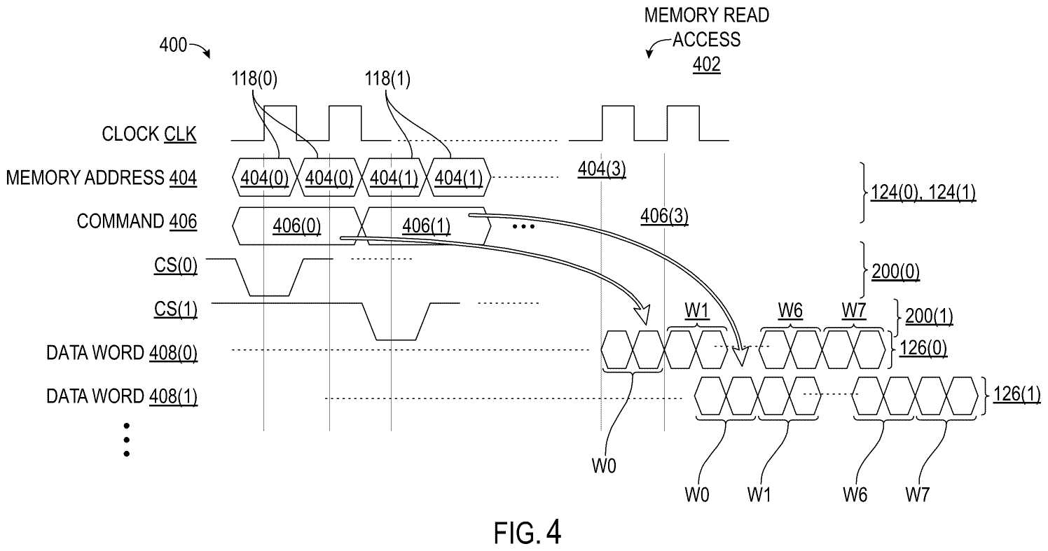

FIG. 4 is an exemplary signal timing diagram 400 illustrating the timing of signals involved in performing a memory read access 402 to a given memory address 404 to the memory module 216 configured in an x4 arrangement in FIG. 2 to support single data word memory accesses, but wherein the memory accesses can also be controlled to output sequential data words of a memory line. The memory read access 402 shown in FIG. 4 is to perform distinct, but sequential memory read accesses to the RAM chips 118(0)-118(3) in the first memory channel 204(0) of the memory module 216, but note that the signals involved with performing the memory read access 402 could also be applied to the other RAM chips 118(4)-118(7) in the second memory channel 204(1) of the memory module 216. As shown in FIG. 4, a clock signal CLK is provided to the memory module 216 of the desired frequency. The memory read access 402 in FIG. 4 assumes that data is being read by memory pages that are already open. If the RAM chips 118(0)-118(3) are DDR DRAM chips as an example, the memory module 216 is configured to provide data transfers on both the rising and falling edges of the clock signal CLK.

As shown in FIG. 4, to initiate a memory read access to the first memory channel 204(0), memory addresses 404(0)-404(3) are asserted on the C/A bus 124(0) in the memory module 216 in FIG. 2 to address the RAM chips 118(0), 118(1) as addressed RAM chips 118(0), 118(1). Note that only two RAM chips 118(0), 118(1) are shown as being accessed in FIG. 4, but the other two (2) RAM chips 118(2), 118(3) in the first memory channel 204(0) can also be accessed sequentially in the same manner as the RAM chips 118(0), 118(1) are accessed. Sequential read commands 406(0), 406(1) are also asserted on the C/A bus 124(0) sequentially in the memory module 216 in FIG. 2 to address the RAM chips 118(0), 118(1). Chip select enable signals CS(0), CS(1) are shown being asserted on the respective, separate chip select inputs 200(0), 200(1) for the RAM chips 118(0), 118(1). Note that only two chip select enable signals CS(0), CS(1) are shown being asserted to activate the RAM chips 118(0), 118(1), but the other chip selects can be asserted to access the other RAM chips 118(2), 118(3) if desired. Then, in response to these signals being asserted to perform the memory read access 402, the activated RAM chips 118(0), 118(1) are each configured to individually and separately assert (by activation through their separate chip select inputs 200(0), 200(1)) respective 8B data words 408(0), 408(1) consisting of eight (8) data burst segments W0-W7, each of which consists of two (2) 4-bit data burst chunks, on the respective data buses 126(0), 126(1). The same can also be performed for the other RAM chips 118(2), 118(3) in the first memory channel 204(0) in this example. In this manner, the RAM chips 118(0)-118(3) in the first memory channel 204(0) can be controlled to individually assert data words W0-W7 on their respective data buses 126(0)-126(3) sequentially in a pipelined manner without stalls for efficient memory access times with reduced memory latency. Note that the memory read access 402 shown in FIG. 4 can also be performed in the second memory channel 204(1) in the memory module 216, but with the signals asserted on the respective inputs and buses for the second memory channel 204(1).

Again, the memory module 216 supports individual access to data words (e.g., W0-W7) from each RAM chip 118(0)-118(7) in the memory module 216 through providing individual chip select inputs in the memory module 216, but how these RAM chips 118(0)-118(7) are accessed is based on the particular signals asserted as desired. The memory module 216 provides the flexibility of accessing each of the RAM chips 118(0)-118(7) separately and distinctly for memory accesses.

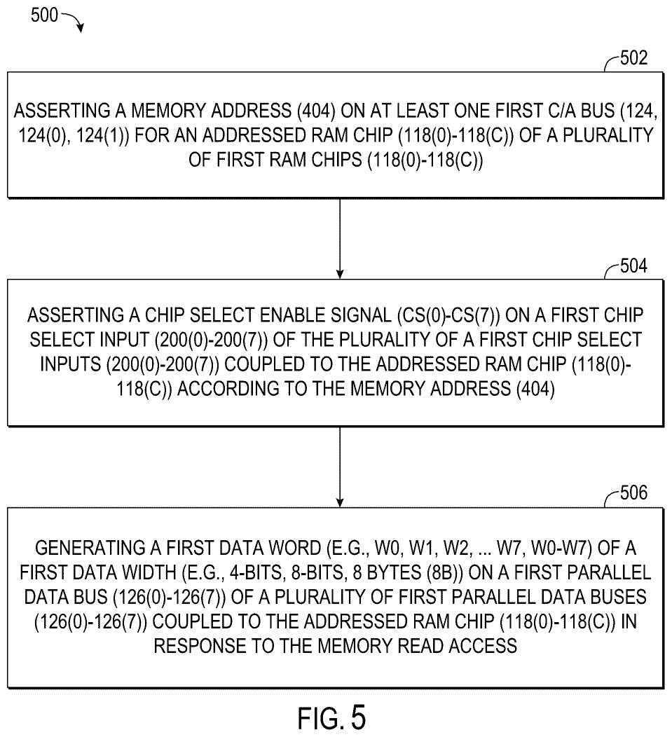

FIG. 5 is a flowchart illustrating an exemplary memory read access process 500 of performing a memory read access in the memory module 216 in FIG. 2 that is generalized from the memory read access 402 in FIG. 4. The signals and elements of the memory module 216 in FIG. 2 and the memory read access 402 in FIG. 4 are referenced, but note that the memory read access process 500 is not limited to the memory read access 402 in the example in FIG. 4.

In this regard, as shown in FIG. 5, a first step of the memory read access process 500 can be asserting a memory address 404 on at least one first C/A bus 124, 124(0), 124(1) for an addressed RAM chip 118(0)-118(C) of the plurality of first RAM chips 118(0)-118(C) (block 502 in FIG. 5). In the example memory module 216 in FIG. 2, the memory address 404 is asserted on the first CA/bus 124(0) to access the first memory channel 204(0), and is asserted on the second CA/bus 124(1) to access the second memory channel 204(1). A next step of the memory read access process 500 can be asserting a chip select enable signal CS(0)-CS(7) on a first chip select input 200(0)-200(7) of the plurality of first chip select inputs 200(0)-200(7) coupled to the addressed RAM chip 118(0)-118(C) according to the memory address 404(block 504 in FIG. 5). The chip select signal CS(0)-CS(7) is asserted on the first chip select input 200(0)-200(7) of the desired RAM chip 118(0)-118(7) to be accessed. A next step of the memory read access process 500 can be generating a first data word (e.g., W0, W1, W2, . . . . W7, W0-W7) of the first data width (e.g., 4 bits, 8 bits, 8 bytes (8B)) on a first parallel data bus 126(0)-126(7) of the plurality of first parallel data buses 126(0)-126(7) coupled to the addressed RAM chip 118(0)-118(C) in response to the memory read access (block 506 in FIG. 5). For example, if memory bursting is not performed, the data word accessed would be a data word of the data width of the respective data bus 126(0)-126(7), which would be 4 bits in the x4 memory module 216 in FIG. 2. If memory bursting is performed, the data word accessed would be a data word of the data width of the respective data bus 126(0)-126(7) times the bursting length, which would be 4 bits×16 burst (i.e., 8B) in the x4 memory module 216 in FIG. 2.

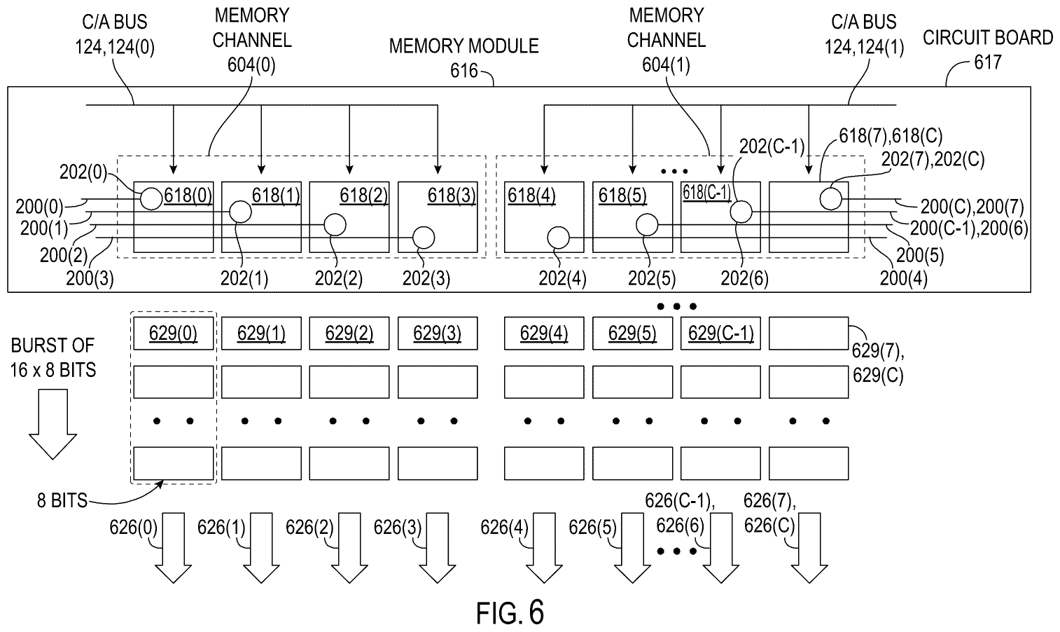

FIG. 6 is a block diagram of an exemplary x8 memory module 616 that can be provided as the memory module 116 in FIG. 1. In this example, the memory module 616 includes eight (8) x8 RAM chips 618(0)-618(7), 618(C) in a DIMM with four (4) RAM chips 618(0)-618(3), 618(4)-618(7), in separate memory channels 604(0), 604(1) to provide two (2) memory channels. The memory module 616 is a module or memory “stick” that contains the plurality of RAM chips 618(0)-118(C) mounted on a dedicated circuit board 617 to form a memory circuit. The circuit board 617 of the memory module 616 can be designed to fit in a specific sized slot on a CPU motherboard for example. For example, the memory module 616 may be an IMM, such as a SIMM or a DIMM.

As shown in FIG. 6, each x8 RAM chip 618(0)-618(C), 618(7) of the memory module 616 has eight (8)-bit wide data output. As discussed in more detail below, each RAM chip 618(0)-618(7), 618(C) in each memory channel 604(0), 604(1) in the memory module 616 is separately controllable to support single data word access from each of the RAM chips individually. In this example, to also avoid a restriction of the x8 memory module 616 only having a full memory line resolution for a memory access, the memory module 616 is configured to support distinct, individual access control to each RAM chip 618(0)-618(C) to be accessed to obtain a data word from each RAM chip 618(0)-618(C) independently of each other. In other words, the memory module 616 is configured to process a memory request that provides access to a data word from each RAM chip 618(0)-618(C) independently without such memory access having to access a data word from each RAM chip 618(0)-618(C) as part of the same memory line. As shown in the memory module 616 in FIG. 6, the x8 memory module 616 is also configured to have the separate chip select input 200(0)-200(C), 200(7) coupled to each of a respective chip select pin 202(0)-202(C) of each RAM chip 618(0)-618(C) therein so that each RAM chip 618(0)-618(C) can be individually and selectively enabled.

In this manner, a memory access can be performed to a specific RAM chip 618(0)-618(C) of a memory channel 604(0), 604(1) in the memory module 616 so that the memory access can be the size of a single data word resolution of each RAM chip 618(0)-618(C) (e.g., 8 bits for an x8 DRAM chip X memory bursting provided, if any) to allow higher data utilization of the memory module 616. Thus, the memory module 616 that supports individual access to each RAM chip 618(0)-618(C) can be used in a memory system, like the memory system 108 in FIG. 1, and achieve the benefit of distinct, multiple single-word memory accesses to the memory module 616. Providing individual control of the RAM chips 618(0)-618(C) provides flexibility in a memory channel being accessed either randomly to obtain a series of data words for irregular memory workloads, or sequentially for high spatial locality memory workloads to duplicate accessing an entire memory line, as desired. However, in either scenario of random irregular memory workloads or high spatial locality memory workloads, data utilization remains high achieving a higher utilization of the memory module 616 bandwidth.

Memory read and write accesses to the memory module 616 in FIG. 6 can be performed like described above for the memory module 216 in FIG. 2.

With continuing reference to FIG. 6, the memory module 616 in this example is an x8 memory module that has eight (8) x8 RAM chips 618(0)-618(7) each having eight (8) respective data output pins 629(0)-629(C). The data buses 626(0)-626(0) each have eight (8) data output pins to each be eight (8) bits in width. The RAM chips 618(0)-618(7) are each DDR DRAM chips in this example. Four (4) of the RAM chips 618(0)-618(3) are part of the first memory channel 604(0), and the other four (4) RAM chips 618(4)-618(7) are part of the second, separate memory channel 204(1). Data buses 626(0)-626(3) coupled to the respective RAM chips 618(0)-618(3) are part of the first memory channel 604(0). Data buses 626(4)-626(7) coupled to respective RAM chips 618(4)-618(7) are part of the second memory channel 604(1). Each memory channel 604(0), 604(1) has a dedicated C/A bus 0 124(0) and C/A bus 1 124(1) to provide respective commands and memory addresses to the RAM chips 618(0)-618(3), 618(4)-618(7) of the respective first and second memory channels 604(0), 604(1). The eight (8) separate chip select inputs 200(0)-200(7) are coupled to each respective RAM chip 618(0)-618(7), with chip select inputs 200(0)-200(3) being part of the first memory channel 604(0), and chip select inputs 200(4)-200(7) being part of the second memory channel 604(1). Memory accesses can be performed to each of the first and second memory channels 604(0), 604(1).

As shown in FIG. 6, each data bus 626(0)-626(3), 626(4)-626(7) is 8 bits in width in this x8 memory module 616 for each memory channel 604(0), 604(1). Thus, for each memory access to a given memory channel 604(0), 604(1), the memory module 616 is configured support 8-bit data words (1B) on each respective data bus 626(0)-626(3), 626(4)-626(7), or 8B across all data buses 626(0)-626(7). Then, with memory bursting of sixteen (16) as an example, the memory module 616 can support burst accesses of sixteen (16) 8-bit data words or 16B (a double 8B data word) on each respective data bus 626(0)-626(3), 626(4)-626(7) for each respective memory channel 604( ) 604(2), or 128B across all data buses 626(0)-626(7). In this example, if a memory line is 64B, each memory channel 604(0), 604(1) supports accesses to separate memory lines each of 64B each. Thus, in the memory module 616, RAM chips 618(0)-618(7) each of the separate memory channels 604(0), 604(1) can be distinctly and randomly read or written to read or write eight (8) total distinct data words each of 8B each for a total of a 64B each, or sequentially read or written in memory to provide a 64B memory line where each of the eight (8) data words are in the same memory line.

To perform a memory read access to each of the respective first and second memory channels 604(0), 606(1) in the memory module 616, a memory address is asserted (e.g., by the memory controller 112 in FIG. 1) on the first and second C/A buses 124(0), 124(1) to address a respective RAM chip(s) 618(0)-618(3), 618(4)-618(7). Note that both memory channels 604(0), 604(1) can be addressed independently. A chip select enable signal is asserted on respective chip select inputs 200(0)-200(3), 200(4)-200(7) coupled to respective chip select pins 202(0)-202(3), 202(4)-202(7) for the RAM chips 618(0)-618(3), 618(4)-618(7) in the accessed memory channel 604(0), 604(1) to be accessed to activate the individual RAM chips 618(0)-618(3), 618(4)-618(7) selected to be accessed. In response to these signals of the memory read accesses, the memory module 616 and its selected activated RAM chip 618(0)-618(3), 618(4)-618(7) in each respective memory channel 204(0), 204(1) asserts a data word stored in its memory onto a respective data bus 626(0)-626(3), 624(4)-626(7). Because the memory module 616 is configured to be able to distinctly access each RAM chip 618(0)-618(7), the memory module 616 is configured to not assert data words from other non-selected RAM chips 618(0)-618(7) onto their respective data buses 626(0)-626(7) for the specific memory read accesses to each respective memory channel 604(0), 604(1). Other data words from other RAM chips 618(0)-618(3), 618(4)-618(7) of each respective memory channel 604(0), 604(1) can be requested to be read for subsequent read access transactions in a different clock cycle(s).

To perform a memory write access in this example of the x8 memory module 616 in FIG. 6, data words are asserted on respective data buses 626(0)-626(3), 626(4)-626(7) of respective RAM chips 618(0)-618(3), 618(4)-618(7) for each respective memory channel 604(0), 604(1) selected for the write access, write memory addresses on respective C/A buses 124(0), 124(1) to address the selected RAM chip(s) 618(0)-618(3), 618(4)-618(7), and a chip select enable signal on the respective chip select inputs 200(0)-200(3), 200(4)-200(7) coupled to the respective chip select pins 202(0)-202(3), 202(4)-202(7) for each memory channel 604(0), 604(1). In response to these signals of the memory write accesses, the memory module 616 and its selected activated RAM chips 618(0)-618(3), 618(4)-618(7) couple the data word on the respective data buses 626(0)-626(3), 626(4)-626(7) for each memory channel 604(0), 604(1) into the memory locations in their memory according to the memory addresses on the respective C/A buses 124(0), 124(1). Again, because the memory module 616 is configured to be able to distinctly access each RAM chip 618(0)-618(3), 618(4)-618(7) for each respective memory channel 604(0), 604(1), in one example, the memory module 616 is configured to couple data words from other non-selected RAM chips 618(0)-618(3), 618(4)-618(7) onto their respective data buses 626(0)-626(3), 626(4)-626(7) of each respective memory channel 604(0), 604(1) for the specific memory write accesses to the respective memory channels 604(0), 604(1). Other data words from other RAM chips 618(0)-618(3), 618(4)-618(7) of the respective memory channels 604(0), 604(1) can be requested to be written for subsequent write access transactions in a different clock cycle(s).

The exemplary data layouts illustrated for the memory module 216 in FIGS. 3A and 3B can also be applied to the memory module 616 in FIG. 6. With the memory module 616 in FIG. 6 implementing a data layout of striping a memory/cache line across multiple of the RAM chips 618(0)-618(7), the example data layout in FIG. 3A is applicable. However, each memory/cache line only needs to be striped across four (4) RAM chips 618(0)-618(3) and 618(4)-618(7) as part of separate respective memory channels 604(0), 604(1) if the memory/cache line is 64B since the RAM chips 618(0)-618(7) are x8 RAM chips. With the memory module 616 in FIG. 6 implementing a data layout of mapping each memory/cache line across in a single RAM chip 618(0)-618(7), the example data layout in FIG. 3B is applicable. However, two (2) memory/cache lines of 64B each would be accessed for a memory burst of sixteen (16) since the RAM chips 618(0)-618(7) are x8 RAM chips, or alternatively a memory burst of eight (8) could be performed to access a single memory/cache line of 64B.

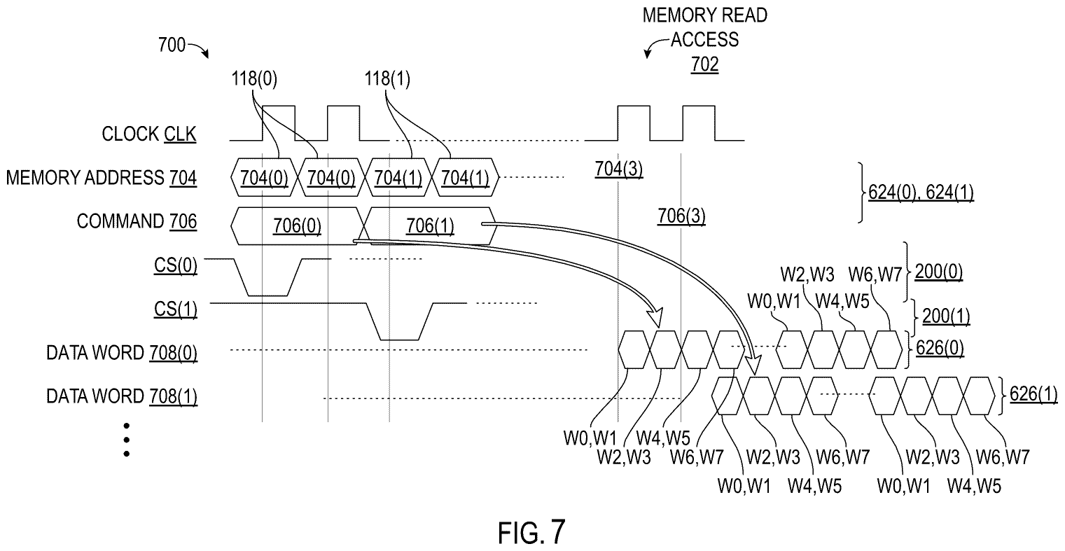

FIG. 7 is an exemplary signal timing diagram of a memory read access process 700 illustrating the timing of signals involved in performing a memory read access 702 to a given memory address 704 to the memory module 616 configured in an x8 arrangement in FIG. 6 to support single data word memory accesses, but wherein the memory accesses can also be controlled to output sequential data words of a memory line. The memory read access 702 shown in FIG. 7 is to perform distinct, but sequential memory read accesses to the RAM chips 618(0)-618(3) in the first memory channel 604(0) of the memory module 616, but note that the signals involved with performing the memory read access 702 could also be applied to the other RAM chips 618(4)-618(7) in the second memory channel 604(1) of the memory module 616. As shown in FIG. 7, a clock signal CLK is provided to the memory module 616 of the desired frequency. The memory read access 702 in FIG. 7 assumes that data is being read by memory pages that are already open. If the RAM chips 618(0)-618(3) are DDR DRAM chips as an example, the memory module 616 is configured to provide data transfers on both the rising and falling edges of the clock signal CLK.

As shown in FIG. 7, to initiate a memory read access to the first memory channel 604(0), memory addresses 704(0)-704(3) are asserted on the C/A bus 124(0) in the memory module 616 in FIG. 6 to address the RAM chips 618(0), 618(1) as addressed RAM chips 618(0), 618(1). Note that only two RAM chips 618(0), 618(1) are shown as being accessed in FIG. 7, but the other two (2) RAM chips 618(2), 618(3) can also be accessed in the first memory channel 604(0) sequentially in the same manner as the RAM chips 618(0), 618(1) are accessed. Sequential read commands 606(0), 606(1) are also asserted on the C/A bus 124(0) sequentially in the memory module 616 in FIG. 6 to address the RAM chips 618(0), 618(1). Chip select enable signals CS(0), CS(1) are shown being asserted on the respective, separate chip select inputs 200(0), 200(1) for the RAM chips 618(0), 618(1). Note that only two chip select enable signals CS(0), CS(1) are shown being asserted to activate the RAM chips 618(0), 618(1), but the other chip selects can be asserted to access the other RAM chips 618(2), 618(3) if desired. Then, in response to these signals being asserted to perform the memory read access 702, the activated RAM chips 618(0), 618(1) are each configured to individually and separately assert (by activation through their separate chip select inputs 200(0), 200(1)) respective two (2) 8B data words (i.e., a double 8B data word) each of W0-W7 consisting of a burst 16, two (2) 8-bit data words on the respective data buses 626(0), 626(1). The same can also be performed for the other RAM chips 618(2), 618(3) in the first memory channel 604(0) in this example. In this manner, the RAM chips 618(0)-618(3) in the first memory channel 604(0) can be controlled to individually assert two (2) data words (W0-W7) on their respective data buses 626(0)-626(3) sequentially in a pipelined manner without stalls for efficient memory access times with reduced memory latency.

Note that the memory read access 702 shown in FIG. 7 can also be performed in the second memory channel 604(1) in the memory module 616, but with the signals asserted on the respective inputs and buses for the second memory channel 604(1).

Alternatively, as discussed above, a memory burst of 8 could be employed in the memory read access 702 in FIG. 7 for each accessed RAM chip 618(0)-618(7) to provide a single 8B data word on their respective data buses 626(0)-626(7).

Again, the memory module 616 in FIG. 6 supports individual access to data words (e.g., double data words each of W0-W7) from each RAM chip 618(0)-618(7) in the memory module 616 through providing individual chip select inputs in the memory module 616, but how these RAM chips 618(0)-618(7) are accessed is based on the particular signals asserted as desired. The memory module 616 provides the flexibility of accessing each of the RAM chips 618(0)-618(7) separately and distinctly for memory accesses.

A processor-based system that includes a memory system that can include a memory system that includes one or more memory modules including, but not limited to, the memory modules 216, 616 in FIGS. 2 and 6, that each include multiple RAM chips in the memory module, and wherein each RAM chip in each memory channel is separately controllable to support single data word access from each of the RAM chips individually, and that supports memory accesses according to, but not limited to, the memory access processes 400, 500, 700 in FIGS. 4, 5, and 7; and, and according to any aspects disclosed herein, may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

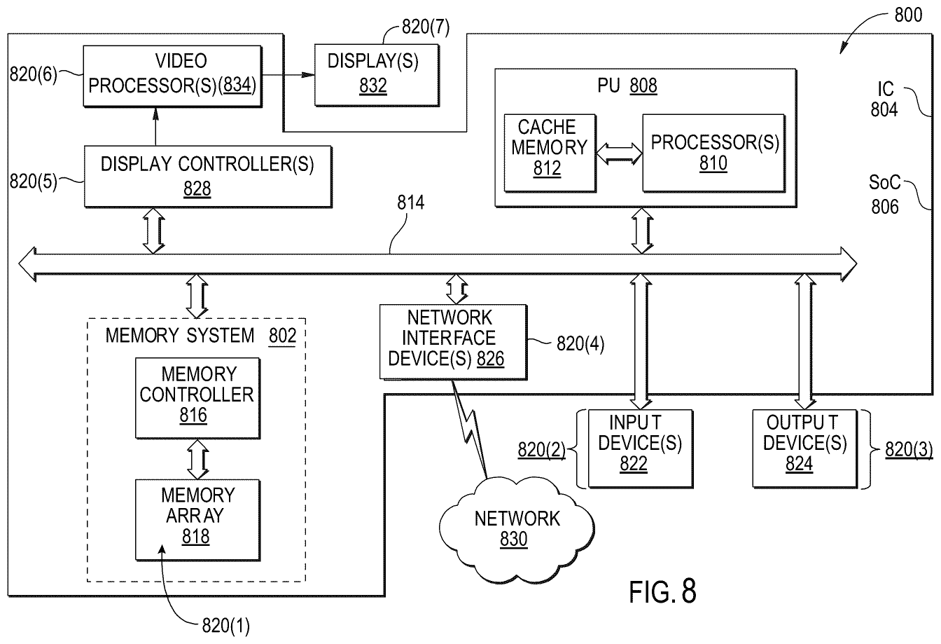

In this regard, FIG. 8 illustrates an example of a processor-based system 800 that includes a memory system 802 that includes one or more memory modules including, but not limited to, the memory modules 216, 616 in FIGS. 2 and 6, that each include multiple RAM chips in the memory module, and wherein each RAM chip in each memory channel is separately controllable to support single data word access from each of the RAM chips individually, and that supports memory accesses according to, but not limited to, the memory access processes 400, 500, 700 in FIGS. 4, 5, and 7, and according to any aspects disclosed herein. For example, the memory system 802 may include one or more memory modules in the form of an IMM(s), such as a SIMM(s) or DIMM(s). In this example, the processor-based system 800 may be formed as an IC 804 and as a system-on-a-chip (SoC) 806. The processor-based system 800 includes a processing unit (PU) 808 that includes one or more processors 810, which can include a central processing unit (CPU), graphics processing unit (GPU), and neural processing unit (NPU). The PU 808 may have a shared cache memory 812 coupled to the PU 808 for rapid access to temporarily stored data.

The processors 810 are coupled to a system bus 814 and can intercouple master and slave devices included in the processor-based system 800. As is well known, the processors 810 communicate with these other devices by exchanging address, control, and data information over the system bus 814. For example, the processors 810 can communicate bus transaction requests to a memory controller 816, as an example of a slave device. Although not illustrated in FIG. 8, multiple system buses 814 could be provided, wherein each system bus 814 constitutes a different fabric.

Other master and slave devices can be connected to the system bus 814. As illustrated in FIG. 8, these devices can include the memory system 802 that includes the memory controller 816 and a memory array(s) 818. The memory array 818 and/or the memory system 802 can include one or more memory modules 820(1) including, but not limited to, the memory modules 216, 616 in FIGS. 2 and 6, that each include multiple RAM chips in the memory module, and wherein each RAM chip in each memory channel is separately controllable to support single data word access from each of the RAM chips individually, and that supports memory accesses according to, but not limited to, the memory access processes 400, 500, 700 in FIGS. 4, 5, and 7, and according to any aspects disclosed herein.

With continuing reference to FIG. 8, the processor-based system 800 also includes one or more input devices 822, one or more output devices 824, one or more network interface devices 826, and one or more display controllers 828 as examples. The input device(s) 822 can include any type of input device, including, but not limited to, input keys, switches, voice processors, etc. The output device(s) 824 can include any type of output device, including, but not limited to, audio, video, other visual indicators, etc. The network interface device(s) 826 can be any device configured to allow exchange of data to and from a network 830. The network 830 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 730 can be configured to support any type of communications protocol desired.

The processors 810 may also be configured to access the display controller(s) 828 over the system bus 814 to control information sent to one or more displays 832. The display controller(s) 828 sends information to the display(s) 832 to be displayed via one or more video processors 834, which process the information to be displayed into a format suitable for the display(s) 832. The display controller(s) 828 and video processor(s) 834 can be included in the same or different ICs, or in the same IC 804 containing the PU 808, as examples. The display(s) 732 can include any type of display, including, but not limited to, a cathode ray tube (CRT), a liquid crystal display (LCD), a plasma display, a light emitting diode (LED) display, etc.

Any of the input devices(s) 822, output device(s) 824, network interface device(s) 826, display controller(s) 828, video processor(s) 834, and display(s) 832 can also include one or more respective memory modules 820(2)-820(7) including, but not limited to, the memory modules 216, 616 in FIGS. 2 and 6, that each include multiple RAM chips in the memory module, and wherein each RAM chip in each memory channel is separately controllable to support single data word access from each of the RAM chips individually, and that supports memory accesses according to, but not limited to, the memory access processes 400, 500, 700 in FIGS. 4, 5, and 7, and according to any aspects disclosed herein

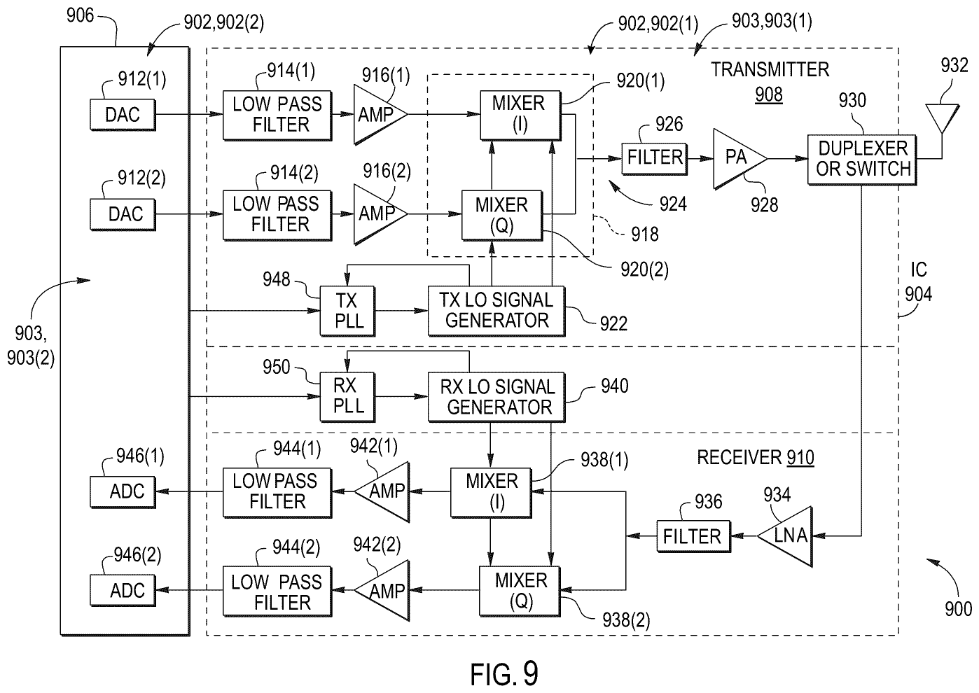

FIG. 9 illustrates an exemplary wireless communications device 900 that includes radio frequency (RF) components and that can include a processor-based system 902, 902(1), 902(2) that includes a respective memory system 903, 903(1), 903(2) that includes one or more memory modules including, but not limited to, the memory modules 216, 616 in FIGS. 2 and 6, that each include multiple RAM chips in the memory module, and wherein each RAM chip in each memory channel is separately controllable to support single data word access from each of the RAM chips individually, and that supports memory accesses according to, but not limited to, the memory access processes 400, 500, 700 in FIGS. 4, 5, and 7, and according to any aspects disclosed herein. The wireless communications device 900 may include or be provided in any of the above-referenced devices, as examples.

As shown in FIG. 9, the wireless communications device 900 includes a transceiver 904 and a data processor 906, each of which may include its processor-based system 902(1), 902(2) that includes the respective memory system 903(1), 903(2) to store data and program codes. The transceiver 904 includes a transmitter 908 and a receiver 910 that support bi-directional communications. In general, the wireless communications device 900 may include any number of transmitters 908 and/or receivers 910 for any number of communication systems and frequency bands. All or a portion of the transceiver 904 may be implemented on one or more analog ICs, RF ICs (RFICs), mixed-signal ICs, etc.

The transmitter 908 or the receiver 910 may be implemented with a super-heterodyne architecture or a direct-conversion architecture. In the super-heterodyne architecture, a signal is frequency-converted between RF and baseband in multiple stages, e.g., from RF to an intermediate frequency (IF) in one stage, and then from IF to baseband in another stage for the receiver 910. In the direct-conversion architecture, a signal is frequency-converted between RF and baseband in one stage. The super-heterodyne and direct-conversion architectures may use different circuit blocks and/or have different requirements. In the wireless communications device 900 in FIG. 9, the transmitter 908 and the receiver 910 are implemented with the direct-conversion architecture.

In the transmit path, the data processor 906 processes data to be transmitted and provides I and Q analog output signals to the transmitter 908. In the exemplary wireless communications device 900, the data processor 906 includes digital-to-analog converters (DACs) 912(1), 912(2) for converting digital signals generated by the data processor 906 into the I and Q analog output signals, e.g., I and Q output currents, for further processing.

Within the transmitter 908, lowpass filters 914(1), 914(2) filter the I and Q analog output signals, respectively, to remove undesired signals caused by the prior digital-to-analog conversion. Amplifiers (AMPs) 916(1), 916(2) amplify the signals from the lowpass filters 914(1), 914(2), respectively, and provide I and Q baseband signals. An upconverter 918 upconverts the I and Q baseband signals with I and Q transmit (TX) local oscillator (LO) signals through mixers 920(1), 920(2) from a TX LO signal generator 922 to provide an upconverted signal 924. A filter 926 filters the upconverted signal 924 to remove undesired signals caused by the frequency up-conversion as well as noise in a receive frequency band. A power amplifier (PA) 928 amplifies the upconverted signal 924 from the filter 926 to obtain the desired output power level and provides a transmit RF signal. The transmit RF signal is routed through a duplexer or switch 930 and transmitted via an antenna 932.

In the receive path, the antenna 932 receives signals transmitted by base stations and provides a received RF signal, which is routed through the duplexer or switch 930 and provided to a low noise amplifier (LNA) 934. The duplexer or switch 930 is designed to operate with a specific receive (RX)-to-TX duplexer frequency separation, such that RX signals are isolated from TX signals. The received RF signal is amplified by the LNA 934 and filtered by a filter 936 to obtain a desired RF input signal. Down-conversion mixers 938(1), 938(2) mix the output of the filter 936 with I and Q RX LO signals (i.e., LO_I and LO_Q) from an RX LO signal generator 940 to generate I and Q baseband signals. The I and Q baseband signals are amplified by AMPs 942(1), 942(2) and further filtered by lowpass filters 944(1), 944(2) to obtain I and Q analog input signals, which are provided to the data processor 906. In this example, the data processor 906 includes analog-to-digital converters (ADCs) 946(1), 946(2) for converting the analog input signals into digital signals to be further processed by the data processor 906.

In the wireless communications device 900 of FIG. 9, the TX LO signal generator 922 generates the I and Q TX LO signals used for frequency up-conversion, while the RX LO signal generator 940 generates the I and Q RX LO signals used for frequency down-conversion. Each LO signal is a periodic signal with a particular fundamental frequency. A TX phase-locked loop (PLL) circuit 948 receives timing information from the data processor 906 and generates a control signal used to adjust the frequency and/or phase of the TX LO signals from the TX LO signal generator 922. Similarly, an RX PLL circuit 950 receives timing information from the data processor 906 and generates a control signal used to adjust the frequency and/or phase of the RX LO signals from the RX LO signal generator 940.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device or processing unit, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:

1. A memory module, comprising:
a first memory channel, comprising:
   a plurality of first random access memory (RAM) chips each comprising:
      a plurality of first data output pins;
      a first command/address (C/A) input; and
      a first chip select pin;
   at least one first C/A bus coupled to at least one first C/A input of each of the plurality of first RAM chips;
   a plurality of first chip select inputs each coupled to a respective first chip select pin of a first RAM chip of the plurality of first RAM chips; and
   a plurality of first parallel data buses each coupled to the plurality of first data output pins of a respective first RAM chip of the plurality of first RAM chips;
wherein:
   each first RAM chip of the plurality of first RAM chips is configured to assert a first data word on a first parallel data bus of the plurality of first parallel data buses coupled to the first RAM chip, in response to a memory read address on the at least one first C/A input and a chip select enable signal on a first chip select input of the plurality of first chip select inputs coupled to the first chip select pin of the first RAM chip.

2. The memory module of clause 1, further comprising:
a second memory channel, comprising:
   a plurality of second RAM chips each comprising:
      a plurality of second data output pins;
      a second C/A input; and
      a second chip select pin;
   a second C/A bus coupled to the second C/A input of each of the plurality of second RAM chips;
   a plurality of second chip select inputs each coupled to a respective second chip select pin of a second RAM chip of the plurality of second RAM chips; and
   a plurality of second parallel data buses each coupled to the plurality of second data output pins of a respective second RAM chip of the plurality of second RAM chips;
wherein:
   each second RAM chip of the plurality of second RAM chips is configured to assert a second data word on a second parallel data bus of the plurality of second parallel data buses coupled to the second RAM chip, in response to a memory read address on the second C/A input and a chip select enable signal on a second chip select input of the plurality of second chip select inputs coupled to the second chip select pin of the second RAM chip.

3. The memory module of clause 1, wherein:
the plurality of first RAM chips comprises eight (8) first RAM chips;
the plurality of first data output pins for each first RAM chip of the plurality of first RAM chips comprises four (4) first data output pins;
the plurality of first chip select inputs comprises eight (8) first chip select inputs;
the plurality of first parallel data buses comprises eight (8) first parallel data buses each 4-bits wide; and
each first RAM chip of the eight (8) first RAM chips is configured to assert the first data word comprising a 4-bit data word on a first parallel data bus of the eight (8) first parallel data buses coupled to the first RAM chip, in response to a memory read address on the at least one first C/A input and a chip select enable signal on a first chip select input of the eight (8) first chip select inputs coupled to the first chip select pin of the first RAM chip.

4. The memory module of clause 3, wherein:
the at least one first C/A bus coupled to the at least one first C/A input comprises a first C/A bus coupled to the first C/A input of each of a first four (4) first RAM chips of the eight (8) first RAM chips and a second C/A bus coupled to a second C/A input of each of a second four (4) first RAM chips of the eight (8) first RAM chips not included in the first four (4) first RAM chips;
wherein:
   each of a first RAM chip of the first four (4) first RAM chips is configured to assert the first data word comprising a first 4-bit data word on a first parallel data bus of the plurality of first parallel data buses coupled to the first RAM chip, in response to the memory read address on the first C/A input and the chip select enable signal on the first chip select input of the plurality of first chip select inputs coupled to the first chip select pin of the first RAM chip; and
   each of a second RAM chip of the second four (4) first RAM chips is configured to assert a second data word comprising a second 4-bit data word on a second parallel data bus of the plurality of first parallel data buses coupled to the second RAM chip, in response to the memory read address on the second C/A input and the chip select enable signal on the first chip select input of the plurality of first chip select inputs coupled to the first chip select pin of the second RAM chip.

5. The memory module of clause 1, wherein:
the plurality of first RAM chips comprises eight (8) first RAM chips;
the plurality of first data output pins for each first RAM chip of the plurality of first RAM chips comprises eight (8) first data output pins;
the plurality of first chip select inputs comprises eight (8) first chip select inputs;
the plurality of first parallel data buses comprises eight (8) first parallel data buses each 8-bits wide; and
each first RAM chip of the eight (8) first RAM chips is configured to assert the first data word comprising an 8-bit data word on a first parallel data bus of the eight (8) first parallel data buses coupled to the first RAM chip, in response to the memory read address on the at least one first C/A input and the chip select enable signal on the first chip select input of the eight (8) first chip select inputs coupled to the first chip select pin of the first RAM chip.

6. The memory module of clause 5, wherein:
the at least one first C/A bus coupled to the at least one first C/A input comprises a first C/A bus coupled to the first C/A input of each of a first four (4) first RAM chips of the eight (8) first RAM chips and a second C/A bus coupled to a second C/A input of each of a second four (4) first RAM chips of the eight (8) first RAM chips not included in the first four (4) first RAM chips;
wherein:
   each of a first RAM chip of the first four (4) first RAM chips is configured to assert the first data word comprising a first 8-bit data word on a first parallel data bus of the plurality of first parallel data buses coupled to the first RAM chip, in response to the memory read address on the first C/A input and the chip select enable signal on the first chip select input of the plurality of first chip select inputs coupled to the first chip select pin of the first RAM chip; and
   each of a second RAM chip of the second four (4) first RAM chips is configured to assert a second data word comprising a second 8-bit data word on a second parallel data bus of the plurality of first parallel data buses coupled to the second RAM chip, in response to the memory read address on the second C/A input and the chip select enable signal on the first chip select input of the plurality of first chip select inputs coupled to the first chip select pin of the second RAM chip.

7. The memory module of clause 2, wherein:
the plurality of first RAM chips comprises four (4) first RAM chips;
the plurality of second RAM chips comprises four (4) second RAM chips;
the plurality of first data output pins for each first RAM chip of the four (4) first RAM chips comprises eight (8) first data output pins;
the plurality of second data output pins for each second RAM chip of the four (4) second RAM chips comprises eight (8) second data output pins;
the plurality of first chip select inputs comprises four (4) first chip select inputs;
the plurality of second chip select inputs comprises four (4) second chip select inputs;
the plurality of first parallel data buses comprises four (4) first parallel data buses each 8-bits wide; and
the plurality of second parallel data buses comprises four (4) second parallel data buses each 8-bits wide; and
each first RAM chip of the four (4) first RAM chips is configured to assert the first data word comprising a first 8-bit data word on a first parallel data bus of the four (4) first parallel data buses coupled to the first RAM chip, in response to a first memory read address on the first C/A input and the chip select enable signal on the first chip select input of the four (4) first chip select inputs coupled to the first chip select pin of the first RAM chip; and
each second RAM chip of the four (4) second RAM chips is configured to assert the second data word comprising a second 8-bit data word on a second parallel data bus of the four (4) second parallel data buses coupled to the second RAM chip, in response to a second memory read address on the second C/A input and the chip select enable signal on the second chip select input of the four (4) second chip select inputs coupled to the second chip select pin of the second RAM chip.

8. The memory module of any of clauses 1-7, wherein the plurality of first RAM chips comprises a plurality of dynamic RAM (DRAM) chips.

9. The memory module of clause 8, wherein the plurality of first DRAM chips comprises a plurality of first double data rate (DDR) DRAM chips.

10. The memory module of any of clauses 1-9 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter. 11. A memory system, comprising:
a memory module, comprising:
   a first memory channel, comprising:
      a plurality of first random access memory (RAM) chips each comprising:
         a plurality of first data output pins of a first data width;
         a first command/address (C/A) input; and
         a first chip select pin;
      at least one first C/A bus coupled to at least one first C/A input of each of the plurality of first RAM chips;
      a plurality of first chip select inputs each coupled to a respective first chip select pin of a first RAM chip of the plurality of first RAM chips; and
      a plurality of first parallel data buses each coupled to the plurality of first data output pins of a respective first RAM chip of the plurality of first RAM chips; and
a memory controller coupled to the memory module, the memory controller configured to generate a memory read access by being configured to:
   assert a memory address on the at least one first C/A bus for an addressed RAM chip of the plurality of first RAM chips; and
   assert a chip select enable signal on a first chip select input of the plurality of first chip select inputs coupled to the addressed RAM chip according to the memory address;
the memory module configured to assert a first data word of the first data width on a first parallel data bus of the plurality of first parallel data buses coupled to the addressed RAM chip in response to the memory read access.

12. The memory system of clause 11, wherein the memory module is configured to not assert another data word on any of the plurality of first parallel data buses not including the first parallel data bus in response to the memory read access.

13. The memory system of clause 11 or 12, wherein the memory controller is further configured to generate a plurality of memory read accesses by being configured to:
sequentially assert a plurality of memory addresses on the at least one first C/A bus for the plurality of first RAM chips; and
sequentially assert a plurality of chip select enable signals on the plurality of first chip select inputs coupled to the plurality of first RAM chips according to the respective plurality of memory addresses;
the memory module configured to sequentially assert a plurality of data words on the respective plurality of first parallel data buses coupled to the respective plurality of first RAM chips in response to the respective plurality of memory read accesses.

14. The memory system of any of clauses 11-13, wherein the memory controller is further configured to generate a memory read access for a memory line by being configured to:
sequentially assert a plurality of memory addresses for the memory line on the at least one first C/A bus for each of the plurality of first RAM chips; and
sequentially assert a plurality of chip select enable signals on the plurality of first chip select inputs coupled to each of the plurality of first RAM chips according to the respective plurality of memory addresses;
the memory module configured to sequentially assert a plurality of data words on the plurality of first parallel data buses coupled to the respective plurality of first RAM chips in response to the memory read access.

15. The memory system of any of clauses 11-13, wherein the memory controller is further configured to generate a memory line read access by being configured to:
sequentially assert a plurality of memory addresses for a memory line on the at least one first C/A bus for the addressed RAM chip of the plurality of first RAM chips; and
sequentially assert a plurality of chip select enable signals on the first chip select input of the plurality of first chip select inputs coupled to the addressed RAM chip according to the plurality of memory addresses;
the memory module configured to sequentially assert a plurality of data words on the first parallel data bus of the plurality of parallel data buses coupled to the respective addressed RAM chip in response to the memory line read access.

16. The memory system of any of clauses 11-15, wherein:
the plurality of first RAM chips comprises eight (8) first RAM chips;
the plurality of first data output pins for each first RAM chip of the plurality of first RAM chips comprises four (4) first data output pins;
the plurality of first chip select inputs comprises eight (8) first chip select inputs;
the plurality of first parallel data buses comprises eight (8) first parallel data buses each 4-bits wide;
the memory controller is configured to:
   assert the chip select enable signal on a first chip select input of the eight (8) first chip select inputs coupled to the first chip select pin of the first RAM chip; and
   the memory module is configured to assert the first data word of the first data width by being configured to assert the first data word comprising a 4-bit data word on a first parallel data bus of the eight (8) first parallel data buses coupled to the first RAM chip.

17. The memory system of any of clauses 11-15, wherein:
the plurality of first RAM chips comprises eight (8) first RAM chips;
the plurality of first data output pins for each first RAM chip of the plurality of first RAM chips comprises eight (8) first data output pins;
the plurality of first chip select inputs comprises eight (8) first chip select inputs;
the plurality of first parallel data buses comprises eight (8) first parallel data buses each 8-bits wide; and
the memory controller is configured to:
   assert the chip select enable signal on a first chip select input of the eight (8) first chip select inputs coupled to the first chip select pin of the first RAM chip; and
the memory module is configured to assert the first data word of the first data width by being configured to assert the first data word comprising an 8-bit data word on a first parallel data bus of the eight (8) first parallel data buses coupled to the first RAM chip.

18. The memory system of clause 17, wherein:
the memory controller is further configured to:
   assert a second chip select enable signal on a first chip select input of the eight (8) first chip select inputs coupled to the first chip select pin of another first RAM chip of the plurality of first RAM chips; and
the memory module is further configured to assert a second data word of the first data width by being configured to assert the second data word comprising an 8-bit data word on another first parallel data bus of the eight (8) first parallel data buses coupled to the other first RAM chip.

19. The memory system of any of clauses 11-18, wherein the plurality of first RAM chips comprises a plurality of first dynamic RAM (DRAM) chips.

20. A method of performing a memory access to a memory module comprising a first memory channel, comprising:
a plurality of first random access memory (RAM) chips each comprising:
   a plurality of first data output pins of a first data width;
   a first command/address (C/A) input; and
   a first chip select pin;
at least one first C/A bus coupled to at least one first C/A input of each of the plurality of first RAM chips;
a plurality of first chip select inputs each coupled to a respective first chip select pin of a first RAM chip of the plurality of first RAM chips; and
a plurality of first parallel data buses each coupled to the plurality of first data output pins of a respective first RAM chip of the plurality of first RAM chips; and
the method comprising:
   asserting a memory address on the at least one first C/A bus for an addressed RAM chip of the plurality of first RAM chips; and
   asserting a chip select enable signal on a first chip select input of the plurality of first chip select inputs coupled to the addressed RAM chip according to the memory address; and
   generating, by the memory module, a first data word of the first data width on a first parallel data bus of the plurality of first parallel data buses coupled to the addressed RAM chip in response to a memory read access.

What is claimed is:

1. A memory module, comprising:
a first memory channel, comprising:
a plurality of first random access memory (RAM) chips each comprising:
a plurality of first data output pins;
a first command/address (C/A) input; and
a first chip select pin;
at least one first C/A bus coupled to at least one first C/A input of each of the plurality of first RAM chips;
a plurality of first chip select inputs each coupled to a respective first chip select pin of a first RAM chip of the plurality of first RAM chips; and
a plurality of first parallel data buses each coupled to the plurality of first data output pins of a respective first RAM chip of the plurality of first RAM chips;
wherein:
each first RAM chip of the plurality of first RAM chips is configured to assert a first data word on a first parallel data bus of the plurality of first parallel data buses coupled to the first RAM chip, in response to a memory read address on the at least one first C/A input and a chip select enable signal on a first chip select input of the plurality of first chip select inputs coupled to the first chip select pin of the first RAM chip.

2. The memory module of claim 1, further comprising:
a second memory channel, comprising:
a plurality of second RAM chips each comprising:
a plurality of second data output pins;
a second C/A input; and
a second chip select pin;
a second C/A bus coupled to the second C/A input of each of the plurality of second RAM chips;
a plurality of second chip select inputs each coupled to a respective second chip select pin of a second RAM chip of the plurality of second RAM chips; and
a plurality of second parallel data buses each coupled to the plurality of second data output pins of a respective second RAM chip of the plurality of second RAM chips;
wherein:
each second RAM chip of the plurality of second RAM chips is configured to assert a second data word on a second parallel data bus of the plurality of second parallel data buses coupled to the second RAM chip, in response to a memory read address on the second C/A input and a chip select enable signal on a second chip select input of the plurality of second chip select inputs coupled to the second chip select pin of the second RAM chip.

3. The memory module of claim 1, wherein:
the plurality of first RAM chips comprises eight (8) first RAM chips;
the plurality of first data output pins for each first RAM chip of the plurality of first RAM chips comprises four (4) first data output pins;
the plurality of first chip select inputs comprises eight (8) first chip select inputs;
the plurality of first parallel data buses comprises eight (8) first parallel data buses each 4-bits wide; and
each first RAM chip of the eight (8) first RAM chips is configured to assert the first data word comprising a 4-bit data word on a first parallel data bus of the eight (8) first parallel data buses coupled to the first RAM chip, in response to a memory read address on the at least one first C/A input and a chip select enable signal on a first chip select input of the eight (8) first chip select inputs coupled to the first chip select pin of the first RAM chip.

4. The memory module of claim 3, wherein:
the at least one first C/A bus coupled to the at least one first C/A input comprises a first C/A bus coupled to the first C/A input of each of a first four (4) first RAM chips of the eight (8) first RAM chips and a second C/A bus coupled to a second C/A input of each of a second four (4) first RAM chips of the eight (8) first RAM chips not included in the first four (4) first RAM chips;
wherein:
each of a first RAM chip of the first four (4) first RAM chips is configured to assert the first data word comprising a first 4-bit data word on a first parallel data bus of the plurality of first parallel data buses coupled to the first RAM chip, in response to the memory read address on the first C/A input and the chip select enable signal on the first chip select input of the plurality of first chip select inputs coupled to the first chip select pin of the first RAM chip; and
each of a second RAM chip of the second four (4) first RAM chips is configured to assert a second data word comprising a second 4-bit data word on a second parallel data bus of the plurality of first parallel data buses coupled to the second RAM chip, in response to the memory read address on the second C/A input and the chip select enable signal on the first chip select input of the plurality of first chip select inputs coupled to the first chip select pin of the second RAM chip.

5. The memory module of claim 1, wherein:
the plurality of first RAM chips comprises eight (8) first RAM chips;
the plurality of first data output pins for each first RAM chip of the plurality of first RAM chips comprises eight (8) first data output pins;
the plurality of first chip select inputs comprises eight (8) first chip select inputs;
the plurality of first parallel data buses comprises eight (8) first parallel data buses each 8-bits wide; and
each first RAM chip of the eight (8) first RAM chips is configured to assert the first data word comprising an 8-bit data word on a first parallel data bus of the eight (8) first parallel data buses coupled to the first RAM chip, in response to the memory read address on the at least one first C/A input and the chip select enable signal on the first chip select input of the eight (8) first chip select inputs coupled to the first chip select pin of the first RAM chip.

6. The memory module of claim 5, wherein:
the at least one first C/A bus coupled to the at least one first C/A input comprises a first C/A bus coupled to the first C/A input of each of a first four (4) first RAM chips of the eight (8) first RAM chips and a second C/A bus coupled to a second C/A input of each of a second four (4) first RAM chips of the eight (8) first RAM chips not included in the first four (4) first RAM chips;
wherein:
each of a first RAM chip of the first four (4) first RAM chips is configured to assert the first data word comprising a first 8-bit data word on a first parallel data bus of the plurality of first parallel data buses coupled to the first RAM chip, in response to the memory read address on the first C/A input and the chip select enable signal on the first chip select input of the plurality of first chip select inputs coupled to the first chip select pin of the first RAM chip; and
each of a second RAM chip of the second four (4) first RAM chips is configured to assert a second data word comprising a second 8-bit data word on a second parallel data bus of the plurality of first parallel data buses coupled to the second RAM chip, in response to the memory read address on the second C/A input and the chip select enable signal on the first chip select input of the plurality of first chip select inputs coupled to the first chip select pin of the second RAM chip.

7. The memory module of claim 2, wherein:
the plurality of first RAM chips comprises four (4) first RAM chips;
the plurality of second RAM chips comprises four (4) second RAM chips;
the plurality of first data output pins for each first RAM chip of the four (4) first RAM chips comprises eight (8) first data output pins;
the plurality of second data output pins for each second RAM chip of the four (4) second RAM chips comprises eight (8) second data output pins;
the plurality of first chip select inputs comprises four (4) first chip select inputs;
the plurality of second chip select inputs comprises four (4) second chip select inputs;
the plurality of first parallel data buses comprises four (4) first parallel data buses each 8-bits wide; and
the plurality of second parallel data buses comprises four (4) second parallel data buses each 8-bits wide; and
each first RAM chip of the four (4) first RAM chips is configured to assert the first data word comprising a first 8-bit data word on a first parallel data bus of the four (4) first parallel data buses coupled to the first RAM chip, in response to a first memory read address on the first C/A input and the chip select enable signal on the first chip select input of the four (4) first chip select inputs coupled to the first chip select pin of the first RAM chip; and
each second RAM chip of the four (4) second RAM chips is configured to assert the second data word comprising a second 8-bit data word on a second parallel data bus of the four (4) second parallel data buses coupled to the second RAM chip, in response to a second memory read address on the second C/A input and the chip select enable signal on the second chip select input of the four (4) second chip select inputs coupled to the second chip select pin of the second RAM chip.

8. The memory module of claim 1, wherein the plurality of first RAM chips comprises a plurality of dynamic RAM (DRAM) chips.

9. The memory module of claim 8, wherein the plurality of first DRAM chips comprises a plurality of first double data rate (DDR) DRAM chips.

10. The memory module of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

11. A memory system, comprising:
a memory module, comprising:
a first memory channel, comprising:
a plurality of first random access memory (RAM) chips each
comprising:
a plurality of first data output pins of a first data width;
a first command/address (C/A) input; and
a first chip select pin;
at least one first C/A bus coupled to at least one first C/A input of each of the plurality of first RAM chips;
a plurality of first chip select inputs each coupled to a respective first chip select pin of a first RAM chip of the plurality of first RAM chips; and
a plurality of first parallel data buses each coupled to the plurality of first data output pins of a respective first RAM chip of the plurality of first RAM chips; and
a memory controller coupled to the memory module, the memory controller configured to generate a memory read access by being configured to:
assert a memory address on the at least one first C/A bus for an addressed RAM chip of the plurality of first RAM chips; and
assert a chip select enable signal on a first chip select input of the plurality of first chip select inputs coupled to the addressed RAM chip according to the memory address;
the memory module configured to assert a first data word of the first data width on a first parallel data bus of the plurality of first parallel data buses coupled to the addressed RAM chip in response to the memory read access.

12. The memory system of claim 11, wherein the memory module is configured to not assert another data word on any of the plurality of first parallel data buses not including the first parallel data bus in response to the memory read access.

13. The memory system of claim 11, wherein the memory controller is further configured to generate a plurality of memory read accesses by being configured to:
sequentially assert a plurality of memory addresses on the at least one first C/A bus for the plurality of first RAM chips; and
sequentially assert a plurality of chip select enable signals on the plurality of first chip select inputs coupled to the plurality of first RAM chips according to the respective plurality of memory addresses;
the memory module configured to sequentially assert a plurality of data words on the respective plurality of first parallel data buses coupled to the respective plurality of first RAM chips in response to the respective plurality of memory read accesses.

14. The memory system of claim 11, wherein the memory controller is further configured to generate a memory read access for a memory line by being configured to:
sequentially assert a plurality of memory addresses for the memory line on the at least one first C/A bus for each of the plurality of first RAM chips; and
sequentially assert a plurality of chip select enable signals on the plurality of first chip select inputs coupled to each of the plurality of first RAM chips according to the respective plurality of memory addresses;
the memory module configured to sequentially assert a plurality of data words on the plurality of first parallel data buses coupled to the respective plurality of first RAM chips in response to the memory read access.

15. The memory system of claim 11, wherein the memory controller is further configured to generate a memory line read access by being configured to:
sequentially assert a plurality of memory addresses for a memory line on the at least one first C/A bus for the addressed RAM chip of the plurality of first RAM chips; and
sequentially assert a plurality of chip select enable signals on the first chip select input of the plurality of first chip select inputs coupled to the addressed RAM chip according to the plurality of memory addresses;
the memory module configured to sequentially assert a plurality of data words on the first parallel data bus of the plurality of parallel data buses coupled to the respective addressed RAM chip in response to the memory line read access.

16. The memory system of claim 11, wherein:
the plurality of first RAM chips comprises eight (8) first RAM chips;
the plurality of first data output pins for each first RAM chip of the plurality of first RAM chips comprises four (4) first data output pins;
the plurality of first chip select inputs comprises eight (8) first chip select inputs;
the plurality of first parallel data buses comprises eight (8) first parallel data buses each 4-bits wide;
the memory controller is configured to:
assert the chip select enable signal on a first chip select input of the eight (8) first chip select inputs coupled to the first chip select pin of the first RAM chip; and
the memory module is configured to assert the first data word of the first data width by being configured to assert the first data word comprising a 4-bit data word on a first parallel data bus of the eight (8) first parallel data buses coupled to the first RAM chip.

17. The memory system of claim 11, wherein:
the plurality of first RAM chips comprises eight (8) first RAM chips;
the plurality of first data output pins for each first RAM chip of the plurality of first RAM chips comprises eight (8) first data output pins;
the plurality of first chip select inputs comprises eight (8) first chip select inputs;
the plurality of first parallel data buses comprises eight (8) first parallel data buses each 8-bits wide; and
the memory controller is configured to:
assert the chip select enable signal on a first chip select input of the eight (8) first chip select inputs coupled to the first chip select pin of the first RAM chip; and
the memory module is configured to assert the first data word of the first data width by being configured to assert the first data word comprising an 8-bit data word on a first parallel data bus of the eight (8) first parallel data buses coupled to the first RAM chip.

18. The memory system of claim 17, wherein:
the memory controller is further configured to:
assert a second chip select enable signal on a first chip select input of the eight (8) first chip select inputs coupled to the first chip select pin of another first RAM chip of the plurality of first RAM chips; and
the memory module is further configured to assert a second data word of the first data width by being configured to assert the second data word comprising an 8-bit data word on another first parallel data bus of the eight (8) first parallel data buses coupled to the other first RAM chip.

19. The memory system of claim 1, wherein the plurality of first RAM chips comprises a plurality of first dynamic RAM (DRAM) chips.

20. A method of performing a memory access to a memory module comprising a first memory channel, comprising:
a plurality of first random access memory (RAM) chips each comprising:
a plurality of first data output pins of a first data width;
a first command/address (C/A) input; and
a first chip select pin;
at least one first C/A bus coupled to at least one first C/A input of each of the plurality of first RAM chips;
a plurality of first chip select inputs each coupled to a respective first chip select pin of a first RAM chip of the plurality of first RAM chips; and
a plurality of first parallel data buses each coupled to the plurality of first data output pins of a respective first RAM chip of the plurality of first RAM chips; and
the method comprising:
asserting a memory address on the at least one first C/A bus for an addressed RAM chip of the plurality of first RAM chips; and
asserting a chip select enable signal on a first chip select input of the plurality of first chip select inputs coupled to the addressed RAM chip according to the memory address; and
generating, by the memory module, a first data word of the first data width on a first parallel data bus of the plurality of first parallel data buses coupled to the addressed RAM chip in response to a memory read access.
